(19) United States
(12) Patent Application Publication
(10) Pub. No.: US 2012/0177315 A1
(43) Pub. Date: Jul. 12, 2012

(54) Wheel Bearing Apparatus For A Vehicle

(75) Inventors: Masaaki Matsuki, Iwata-Shi (JP); Tomoya Yamada, Iwata-Shi (JP); Syougo Suzuki, Iwata-Shi (JP)

(73) Assignee: NTN Corporation, Osaka (JP)

(21) Appl. No.: 13/428,255

(22) Filed: Mar. 23, 2012

Related U.S. Application Data
(63) Continuation of application No. PCT/JP2010/066548, filed on Sep. 24, 2010.

(30) Foreign Application Priority Data
Sep. 25, 2009 (JP) 2009-220090
Dec. 1, 2009 (JP) 2009-273047

(51) Int. Cl. F16C 33/80; F16C 33/78

(52) U.S. Cl. 384/478; 384/480; 384/484

(57) ABSTRACT

A vehicle wheel bearing apparatus has a seal with a metal core and a sealing member. The metal core includes a cylindrical fitting portion press-fit into an end of the inner circumference of an outer member. A radially inner portion extends radially inward from the fitting portion. The sealing member is integrally adhered to the metal core. The sealing member has a side lip that is radially outwardly inclined. Either one of the metal core or the sealing member is formed with a weir portion that extends radially outward from the fitting portion of the metal core. The weir portion opposes the inner-side surface of the wheel mounting flange, via a small axial gap, to form a labyrinth seal. The weir portion also opposes the outer-side end face of the outer member, via a predetermined axial gap, to form an annular discharging groove.

### CROSS-REFERENCE TO RELATED APPLICATIONS

This application is a continuation of International Application No. PCT/JP2010/066548, filed Sep. 24, 2010, which claims priority to Japanese Application Nos. 2009-220090, filed Sep. 25, 2009 and 2009-273047, filed Dec. 1, 2009. The disclosures of the above applications are incorporating herein by reference.

### FIELD

The present disclosure relates to a vehicle wheel bearing apparatus that rotatably supports a wheel of vehicle, such as an automobile, relative to a suspension apparatus. More particularly, the disclosure relates to a vehicle wheel bearing apparatus intended to improve sealability.

### BACKGROUND

The wheel bearing apparatus that supports a wheel of a vehicle rotatably supports a wheel hub. The wheel hub mounts a wheel, via a rolling bearing, and which there are those for driving wheels and those for driven wheels. Due to structural reasons, an inner ring rotation type bearing is used for driving wheels and both the inner ring rotation type and the outer ring rotation type bearing are used for driven wheels. In general, the wheel bearing apparatus is classified as a so-called first, second, third or fourth generation type. In the first generation type, the wheel bearing includes double row angular ball bearings fit between a knuckle and a wheel hub. In the second generation type, a body mounting flange or a wheel mounting flange is directly formed on the outer circumference of an outer member. In the third generation type, one of the inner raceway surfaces is directly formed on the outer circumference of the wheel hub. In the fourth generation type, inner raceway surfaces are directly formed on the outer circumferences, respectively, of the wheel hub and the outer joint member of the constant velocity universal joint.

The wheel bearing apparatus is usually arranged at a position on the vehicle where it is liable to be splashed with muddy water etc. Thus, it has a sealing means to seal a space between the outer member and inner member of the wheel bearing apparatus. As a result of verifying damaged conditions of wheel bearing apparatus recovered from the market, it was found that the wheel bearing apparatus has been damaged, at a high proportion, due to troubles with the sealing means rather than natural causes such as wear or peeling. Accordingly, it will be expected that the life of the bearing apparatus could be increased by improving the sealability and durability of the sealing means. In general, the sealing means of the wheel bearing apparatus is structured so that a sealing member, equipped with sealing lips, is mounted on an outer member to form a stator member and the sealing lips contact an outer circumference of an inner member.

Several sealing structures with improved sealability have been proposed. One example of a prior art wheel bearing apparatus equipped with such a sealing structure is shown in FIG. 18. This wheel bearing apparatus has an outer member 100 formed with double row outer raceway surfaces 100a, 100a in its inner circumference. It is secured on a vehicle body via a knuckle. In addition, a wheel hub 103 and an outer joint member of a constant velocity universal joint (not shown) are rotatably mounted on the outer member 100, via double row balls 102, 102, held equidistantly along their inner and outer raceway surfaces.

An inner raceway surface 103a corresponding to one of the double row outer raceway surfaces 100a, 100a is formed on an outer circumference of the wheel hub 103. A wheel mounting flange 104, on which a brake disc and a wheel (not shown) are mounted, is also formed on one end of the wheel hub 103.

A sealing structure 105 includes an inner-side surface 104a of the wheel mounting flange 104, a metal core 106 and elastic member 107. The metal core 106 is fit into the inner circumference of the outer member 100. The elastic sealing member 107 is secured on the metal core 106. The elastic sealing member 107 includes two axial lip portions 108 that axially contact the side surface 104a of the wheel mounting flange 104. A radial lip portion 109 radially contacts with the outer circumference of the wheel hub 103.

In addition, the metal core 106 is formed with a circular arc-shaped (crescent-shaped) weir portion 106a. The weir portion 106a partially extends radially upward from the outer circumference 100b of the outer member 100 along the side surface 104a of the wheel mounting flange 104. The weir portion 106a is in close contact with the outer-side end face of the outer member 100. Furthermore, the weir portion 106a is arranged only in a region above the axis of the wheel bearing apparatus.

In such a sealing structure 105, it is possible to prevent muddy water from flowing toward the side surface 104a of the wheel mounting flange 104 due to the presence of the weir portion 106a when muddy water splashes over the outer member 100 during running of the vehicle. Accordingly, it is possible to prevent muddy water flowing to the axial lips 108 from the outer circumference of the outer member 100 from residing on the axial lips 108. Thus, it is possible to some extent to maintain the sealability of the wheel bearing apparatus. Patent Document 1: Japanese Laid-open Patent Publication No. 2003-49852.

However, in such a sealing structure 105, since the weir portion 106a is formed only in part of the metal core 106, it is necessary to fit the metal core 106 onto the outer member 100 while matching the phase so that the weir portion 106a is positioned at the top of the outer circumference of the outer member 100 during assembly. This increases the assembly step of assembly. In addition, since the elastic sealing member 107 has a structure that axially contacts the side surface 104a of the wheel mounting flange 104, the distance between the metal core 106 and the side surface 104a of the wheel mounting flange 104 would be necessarily increased. This causes an additional problem that muddy water can flow to the axial lips 108 through a large gap between the metal core 106 and the side surface 104a of the wheel mounting flange 104. Thus, the sealability of the wheel bearing apparatus would be detracted.

### SUMMARY

It is therefore an object of the present disclosure to provide a wheel bearing apparatus with improved sealability. Another object of the present disclosure is to provide a wheel bearing apparatus with improved strength and rigidity while reducing its manufacturing cost.

To achieve the object of the present disclosure, a vehicle wheel bearing apparatus is provided comprising an outer member with a body mounting flange formed on its outer circumference. The body mounting flange is to be mounted on a knuckle. The outer member inner circumference has double row outer raceway surfaces. An inner member includes a wheel hub and at least one inner ring or an outer joint member of a constant velocity universal joint. The wheel hub is formed, on one end, with a wheel mounting flange. A cylindrical portion axially extends from the wheel mounting flange. The inner ring or the outer joint member is fit to the cylindrical portion of the wheel hub. The inner member includes inner raceway surfaces formed on its outer circumference. The inner raceway surfaces oppose the double row outer raceway surfaces. Double row rolling elements are freely rollably contained between the inner raceway surfaces of the inner member and the outer raceway surfaces of the outer member. Seals are mounted within annular openings formed between the outer member and the inner member. The outer-side seal of the seals includes a metal core and a sealing member. The metal core includes a cylindrical fitting portion press-fit into the end of the inner circumference of the outer member. A radially inner portion extends radially inward from the fitting portion. The sealing member is integrally adhered to the metal core and has a side lip inclined radially outward. Either one of the metal core or the sealing member is formed with a weir portion that extends radially outward from the fitting portion of the metal core. The weir portion opposes the inner-side surface of the wheel mounting flange via a small axial gap to form a labyrinth seal. The weir portion also opposes the outer-side end face of the outer member via a predetermined axial gap to form an annular discharging groove.

Seals are mounted within annular openings formed between the outer member and the inner member of the present disclosure. The outer-side seal of the seals includes a metal core and a sealing member. The metal core includes a cylindrical fitting portion press-fit into the end of inner circumference of the outer member. A radially inner portion extends radially inward from the fitting portion. The sealing member is integrally adhered to the metal core and has a side lip inclined radially outward. Either one of the metal core or the sealing member is formed with a weir portion extending radially outward from the fitting portion of the metal core. The weir portion opposes the inner-side surface of the wheel mounting flange via a small axial gap to form a labyrinth seal. The weir portion also opposes the outer-side end face of the outer member via a predetermined axial gap to form an annular discharging groove. Thus, it is possible to prevent the side lip from being directly splashed with muddy water. In addition, the discharging groove functions as a chute to guide muddy water downward to discharge it from the wheel bearing apparatus. Accordingly, even if the muddy water splashes over the outer circumference of the outer member during running of a vehicle, it is possible to prevent muddy water from flowing through the gap between the wheel mounting flange and the weir. Thus, this improves the durability and sealability of the seal for a long term.

A vehicle wheel bearing apparatus comprises an outer member formed with a body mounting flange on its outer circumference. The body mounting flange is to be mounted on a knuckle. The outer member inner circumference has double row outer raceway surfaces. An inner member includes a wheel hub and at least one inner ring or an outer joint member of a constant velocity universal joint. The wheel hub includes, on one end, a wheel mounting flange. A cylindrical portion axially extends from the wheel mounting flange. The inner ring or the outer joint member is fit to the cylindrical portion of the wheel hub. The inner member is formed with inner raceway surfaces on its outer circumference. The inner raceway surfaces oppose the double row outer raceway surfaces. Double row rolling elements are freely rollably contained between the inner raceway surfaces of the inner member and the outer raceway surfaces of the outer member. Seals are mounted within annular openings formed between the outer member and the inner member. The outer-side seal of the seals includes an integrated seal comprising a metal core and a sealing member. The metal core includes a cylindrical fitting portion press-fit into the end of outer circumference of the outer member. A flange portion extends radially inward from the fitting portion. The flange portion is in close contact with the outer-side end face of the outer member. A radially inner portion is bent and then extends radially inward from the flange portion. The sealing member is integrally adhered, by vulcanizing adhesion, to the radially inner portion of the metal core. The sealing member also has an integrally formed side lip that is inclined radially outward. The side lip slidably contacts the inner-side base portion of the wheel mounting flange, via an axial interference. Either one of the metal core or the sealing member includes an annular disc-shaped weir portion that extends radially outward from the fitting portion of the metal core.

Seals are mounted within annular openings formed between the outer member and the inner member. The outer-side seal of the seals is formed as an integrated seal with a metal core and a sealing member. The metal core includes a cylindrical fitting portion press-fit into the end of outer circumference of the outer member. A flange portion extends radially inward from the fitting portion. The flange portion is in close contact with the outer-side end face of the outer member. A radially inner portion is bent and then extends radially inward from the flange portion. The sealing member is integrally adhered, by vulcanizing adhesion, to the radially inner portion of the metal core. The sealing member also has an integrally formed side lip that is inclined radially outward. The side lip slidably contacts with the inner-side base portion of the wheel mounting flange, via an axial interference. Either one of the metal core or the sealing member includes an annular disc-shaped weir portion that extends radially outward from the fitting portion of the metal core. Thus, it is unnecessary to carry out a matching of phase during assembly of the bearing apparatus so that the weir portion is positioned at the top of the outer circumference of the outer member. In addition, since the cylindrical portions of the seal interfere each other during transport of the seal unit, it is possible to protect grease applied to the sealing lips. Additionally, it is possible to prevent muddy water from flowing through the gap between the wheel mounting flange and the weir portion even if the muddy water splashes over the outer circumference of the outer member during running of a vehicle. Thus, this improves the durability and sealability of the seal for a long term. The weir portion may be formed from a steel sheet integrally press worked with the metal core.

The weir portion is formed so that it has an outer diameter larger than that of the outer-side end outer circumference of the outer member. This enables the weir to effectively perform its function as a weir. Thus, it more effectively prevents muddy water from flowing through the gap between the wheel mounting flange and the weir portion even if the muddy water splashes over the outer circumference of the outer member during running of the vehicle.

The weir portion is inclined toward the wheel mounting flange. According to this structure, since the weir portion is inclined toward the wheel mounting flange, the weir can effectively perform its function as a weir. Thus, it more effectively prevents muddy water from flowing through the gap between the wheel mounting flange and the weir portion even if the muddy water splashes over the outer circumference of the outer member during running of the vehicle. In addition, since the cross-section of the discharging groove is substantially triangle, it is possible to effectively guide the muddy water downwardly that has splashed over the outer circumference of the outer member.

The weir portion is inclined toward the inner-side of the wheel bearing apparatus. This further prevents muddy water from flowing through the gap between the wheel mounting flange and the weir portion if the muddy water splashes over the outer circumference of the outer member during running of the vehicle.

The metal core has a cylindrical overhanging portion that extends axially toward the outer-side from the weir portion. A bent portion extends radially outward from the overhanging portion. The weir and bent portions are integrally formed with each other. The bent portion opposes the inner-side surface of the wheel mounting flange via a small axial gap to form a labyrinth seal. This increases the strength and rigidity of the metal core. Thus, it is possible to prevent plastic deformation of the metal core and its interference with other parts. In addition, it is possible to prevent the seal from being directly splashed with muddy water. Thus, this improves the durability and sealability of the seal for a long term.

The sealing member has a covering portion for covering an exposed surface of the metal core. This suppresses corrosion of the metal core without using expensive stainless steel as the metal core. Also, this reduces the manufacturing cost by using cold rolled steel sheet with a low price and high workability.

The metal core has a flange portion that extends radially outward between the fitting portion and the weir portion. The flange portion is in close contacted with the outer-side end face of the outer member. This enables forming of a stepped configuration in the metal core. Thus, deformation or damage of the metal core, by impingement of pebbles etc., can be prevented due to an increase in the strength and rigidity of the metal core. In addition, it is possible to improve the positioning accuracy in the press-fitting step of the metal core due to presence of its flange portion.

The sealing member is secured to the metal core so that the sealing member extends to part of the fitting portion. This improves the sealability of the fitting portion between the outer member and the metal core. Thus, this prevents infiltration of muddy water etc. from the outside via the fitting portion.

The metal core is continuously covered by the sealing member in a region from the fitting portion to the weir portion. This improves the sealability of the fitting portion between the metal core and the outer member. Also, it suppresses corrosion of the metal core without using expensive stainless steel as the metal core. This reduces the manufacturing cost by using cold rolled steel sheet with a low cost and high workability.

The sealing member covers the fitting portion. The weir portion is integrally formed with the sealing member. This prevents the weir portion from being deformed or damaged by impingement of pebbles etc.

The inner-side base portion of the wheel mounting flange is formed as a curved surface with a circular arc cross-section. The sealing member further has an integrally formed dust lip inclined radially outward at a radially inner position from the side lip. Also, an integrally formed grease lip is inclined toward the inner-side of the bearing. The side lip and the dust lip slidably contact the base portion via a predetermined axial interference. The grease lip slidably contacts with the base portion via a predetermined radial interference.

The inner-side base portion of the wheel mounting flange is formed as a curved surface with a circular arc cross-section. An annular metal member is fit onto the base portion. The sealing member further has an integrally formed dust lip inclined radially outward at a radially inner position from the side lip. An integrally formed grease lip is inclined toward the inner-side of the bearing. The side lip and the dust lip slidably contact the annular metal member, via a predetermined axial interference. The grease lip slidably contacts with the annular metal member, via a predetermined radial interference.

The annular metal member includes a curved portion formed with a circular arc cross-section that corresponds to the curved surface of the base portion. An annular disc-shaped portion extends radially outward from the curved portion. The annular disc-shaped portion is adapted to be in close contact with the inner-side surface of the wheel mounting flange. A cylindrical ceiling portion axially extends toward a direction away from the wheel mounting flange. The ceiling portion is arranged opposite to the outer-side end outer circumference of the outer member, via a small gap, to form a labyrinth seal. This makes it possible to prevent the infiltration of muddy water into the slidably contacted portion between the sealing lips and the annular metal member. In addition, the muddy water flows downward and is discharged through the discharging groove. Thus, even if the muddy water splashes over the outer circumference of the outer member during running of the vehicle, it is possible to improve the durability and sealability of the seal for a long term.

The annular metal member has a bent portion that projects radially outward from the ceiling portion. This improves the rigidity of the annular metal member. Thus, it prevents deformation or damage caused by impingement of pebbles etc.

The base portion is formed with a predetermined radius of curvature “r”. The curved portion of the annular metal member is formed with a predetermined radius of curvature “R”. Thus, there exist a relationship R≧r between the radii of curvature “R” and “r”. This prevents the annular metal member from rising from the circular arc surface of the base portion due to the interference of the curved portion of the annular metal member with the circular arc surface of the base portion when the annular metal member is fit onto the base portion. Thus, a gap is formed between the side surface of the wheel mounting flange and the annular disc-shaped portion. Accordingly, the annular metal member is in close contact with the side surface of the wheel mounting flange. Thus, this variation of interference of each lip can be suppressed to assure stable sealability.

The annular metal member is formed of corrosion resistant steel sheet. The steel sheet has a surface roughness of Ra 0.2-0.6. This prevents the generation of corrosion to maintain sealability for a long term. In addition, it is possible to obtain a good sliding contact surface and thus to maintain the sealing performance of the seal, while suppressing lip wear, even if the wheel bearing apparatus is used in severe circumstances.

The seal is formed as a pack seal with an annular sealing plate and a slinger mounted on the inner member. The sealing plate includes a metal core fit into the end portion of the outer member. A sealing member is integrally adhered to the metal core. The slinger includes a cylindrical fitting portion press-fit onto the inner member, via a predetermined interference. A standing plate portion extends radially outward from the fitting portion. The sealing member has another integrally formed side lip inclined radially outward at a radially inner position from the first side lip. An integrally formed grease lip is inclined toward the inner-side of the bearing. The side lips slidably contact the standing plate portion of the slinger, via a predetermined axial interference. The grease lip slidably contacts the fitting portion of the slinger, via a predetermined radial interference.

An outside seal is arranged on the bearing in addition to the seal. The outside seal has a side lip that slidably contacts the side surface of the weir portion of the metal core, via a predetermined axial interference. This prevents muddy water from flowing through the gap between the wheel mounting flange and the weir portion even if the muddy water splashes over the outer circumference of the outer member during running of the vehicle. Also, it prevents the seal from being directly splashed with muddy water. Thus, this improves the durability and sealability of the seal for a long term.

The outside seal includes a fitting portion fit onto the outer circumference of the wheel mounting flange. An annular disc-shaped portion extends radially inward from the fitting portion. The annular disk-shaped portion is in close contact with an inner-side surface of the wheel mounting flange. A cylindrical overhang portion is bent toward an axially inner-side from the annular disc-shaped portion. The side lip is integrally adhered to the overhang portion by vulcanizing adhesion. The outside seal is secured to the wheel mounting flange by hub bolts secured on the wheel mounting flange.

The outside seal includes a fitting portion fit onto a stepped portion formed on the base portion of the wheel mounting flange. A bent portion extends radially outward from the fitting portion. The side lip is integrally adhered to the bent portion by vulcanizing adhesion.

The vehicle wheel bearing apparatus of the present disclosure comprises an outer member with a body mounting flange formed on its outer circumference. The body mounting flange is to be mounted on a knuckle. The outer member inner circumference includes double row outer raceway surfaces. An inner member includes a wheel hub and at least one inner ring or an outer joint member of a constant velocity universal joint. The wheel hub is formed on one end with a wheel mounting flange. A cylindrical portion axially extends from the wheel mounting flange. The inner ring or the outer joint member is fit to the cylindrical portion of the wheel hub. The inner member is formed with inner raceway surfaces on its outer circumference. The inner raceway surfaces oppose the double row outer raceway surfaces. Double row rolling elements are freely rollably contained between the inner raceway surfaces of the inner member and the outer raceway surfaces of the outer member. Seals are mounted within annular openings formed between the outer member and the inner member. The outer-side seal of the seals includes a metal core and a sealing member. The metal core includes a cylindrical fitting portion press-fit into the end of inner circumference of the outer member. A radially inner portion extends radially inward from the fitting portion. The sealing member is integrally adhered to the metal core and has an inclined radially outward side lip. Either one of the metal core or the sealing member is formed with a weir portion that extends radially outward from the fitting portion of the metal core. The well portion opposes the inner-side surface of the wheel mounting flange, via a small axial gap, to form a labyrinth seal. The weir portion also opposes the outer-side end face of the outer member, via a predetermined axial gap, to form an annular discharging groove. Thus, it is possible to prevent the seal from being directly splashed with muddy water. In addition, the discharging groove functions as a chute to guide muddy water downward to discharge it from the wheel bearing apparatus. Thus, it is possible to prevent muddy water from flowing through the gap between the wheel mounting flange and the weir portion even if the muddy water splashes over the outer circumference of the outer member during running of the vehicle. This improves the durability and sealability of the seal for a long term.

Another vehicle wheel bearing apparatus includes an outer member with a body mounting flange formed on its outer circumference. The body mounting flange is to be mounted on a knuckle. The outer member inner circumference includes double row outer raceway surfaces. An inner member includes a wheel hub and at least one inner ring or an outer joint member of a constant velocity universal joint. The wheel hub is formed on one end with a wheel mounting flange. A cylindrical portion axially extends from the wheel mounting flange. The inner ring or the outer joint member is fit onto the cylindrical portion of the wheel hub. The inner member has inner raceway surfaces formed on its outer circumference. The inner raceway surfaces oppose the double row outer raceway surfaces. Double row rolling elements are freely rollably contained between the inner raceway surfaces of the inner member and the outer raceway surfaces of the outer member. Seals are mounted within annular openings formed between the outer member and the inner member. The outer-side seal of the seals is formed as an integrated seal. It includes a metal core and a sealing member. The metal core includes a cylindrical fitting portion press-fit into the end of outer circumference of the outer member. A flange portion extends radially inward from the fitting portion. The flange portion is in close contact with the outer-side end face of the outer member. A radially inner portion is bent and then extends radially inward from the flange portion. The sealing member is integrally adhered, by vulcanizing adhesion, to the radially inner portion of the metal core. The sealing member also has an integrally formed side lip. The side lip is inclined radially outward. The side lip slidably contacts the inner-side base portion of the wheel mounting flange via an axial interference. Either one of the metal core or the sealing member is formed with an annular disc-shaped weir portion that extends radially outward from the fitting portion of the metal core. Thus, it is unnecessary to carry out the matching of phase during assembly of the bearing apparatus so that the weir portion is positioned at the top of the outer circumference of the outer member. In addition, the cylindrical portions of the seal interfere with each other during transport of a seal unit. Thus, it is possible to protect grease applied to the sealing lips. Further, it is possible to prevent muddy water from flowing through the gap between the wheel mounting flange and the weir portion even if the muddy water splashes over the outer circumference of the outer member during running of the vehicle. Thus, this improves the durability and sealability of the seal for a long term.

Further areas of applicability will become apparent from the description provided herein. The description and specific examples in this summary are intended for purposes of illustration only and are not intended to limit the scope of the present disclosure.

### DRAWINGS

FIG. 1 is a longitudinal section view of a first embodiment of a vehicle wheel bearing apparatus.

FIG. 2(a) is a partially enlarged view of an outer side seal of FIG. 1.

FIG. 2(b) is a partially enlarged view of a modification of FIG. 2(a).

FIG. 2(c) is a partially enlarged view of another modification of FIG. 2(a).

FIGS. 3(a)-(c) are partially enlarged views each showing other modifications of FIG. 2(a).

FIGS. 4(a)-(d) are partially enlarged views each showing the other modification of FIG. 2(a).

FIG. 5 is a longitudinal section view of a second embodiment of a vehicle wheel bearing apparatus.

FIG. 6 is a longitudinal section view of a third embodiment of a vehicle wheel bearing apparatus.

FIG. 7 is a longitudinal section view of a fourth embodiment of a vehicle wheel bearing apparatus.

FIG. 8 is a longitudinal section view of a fifth embodiment of a vehicle wheel bearing apparatus.

FIG. 9 is a partially enlarged view of an outer side seal of FIG. 8.

FIG. 10 is a partially enlarged view of a modification of FIG. 9.

FIG. 11 is a partially enlarged view of another modification of FIG. 9.

FIG. 12 is a partially enlarged view of another modification of FIG. 9.

FIG. 13 is a partially enlarged view of a modification of FIG. 12.

FIG. 14 is a partially enlarged view of another modification of FIG. 12.

FIG. 15(a) is a longitudinal section view of a sixth embodiment of a vehicle wheel bearing apparatus.

FIG. 15(b) is a partially enlarged view of a modification of FIG. 15(a).

FIG. 16 is a partially enlarged view of another modification of FIG. 15(a).

FIGS. 17(a)-(b) are partially enlarged views each of a modification of FIG. 16.

FIG. 18 is a partially enlarged view of a prior art sealing structure.

### DETAILED DESCRIPTION

A vehicle wheel bearing apparatus for a vehicle includes an outer member with a body mounting flange formed on its outer circumference. The body mounting flange is to be mounted on a knuckle. The outer member inner circumference includes double row outer raceway surfaces. An inner member includes a wheel hub and an inner ring. The wheel hub is formed with an inner raceway surface on its outer circumference. The one inner raceway surface opposes one of the double row outer raceway surfaces. A cylindrical portion axially extends from the inner raceway surface. The inner ring is press-fit onto the cylindrical portion of the wheel hub, via a predetermined interference. The inner ring outer circumference includes the other inner raceway surface that opposes the other of the double row outer raceway surfaces. Double row rolling elements are freely rollably contained between the inner raceway surfaces of the inner member and the outer raceway surfaces of the outer member. Seals are mounted within annular openings formed between the outer member and the inner member. The outer-side seal of the seals includes an integrated seal with a metal core and a sealing member. The metal core is formed from corrosion resistant steel sheet. The metal core includes a cylindrical fitting portion press-fit into the end of inner circumference of the outer member. A radially inner portion extends radially inward from the fitting portion. A weir portion extends radially outward from the fitting portion. The sealing member is formed from synthetic rubber and is integrally adhered to the metal core. The sealing member includes a side lip, dust lip and grease lip. The side lip is radially outwardly inclined. The dust lip is radially outwardly inclined at a position radially inward of the side lip. A grease lip is inclined radially inward. The side lip, dust lip and grease lip are integrally formed. The inner-side base portion of the wheel mounting flange is formed as a curved surface with a circular arc cross-section. The side lip and the dust lip slidably contact the inner-side base portion of the wheel mounting flange, via a predetermined axial interference. The grease lip slidably contacts the inner-side base portion of the wheel mounting flange, via a predetermined radial interference. The weir portion opposes the inner-side surface of the wheel mounting flange, via a predetermined axial gap, to form a labyrinth seal. The weir portion also opposes the outer-side end face of the outer member, via a predetermined axial gap, to form an annular discharging groove.

Preferred embodiments of the present disclosure will be hereinafter described with reference to the drawings.

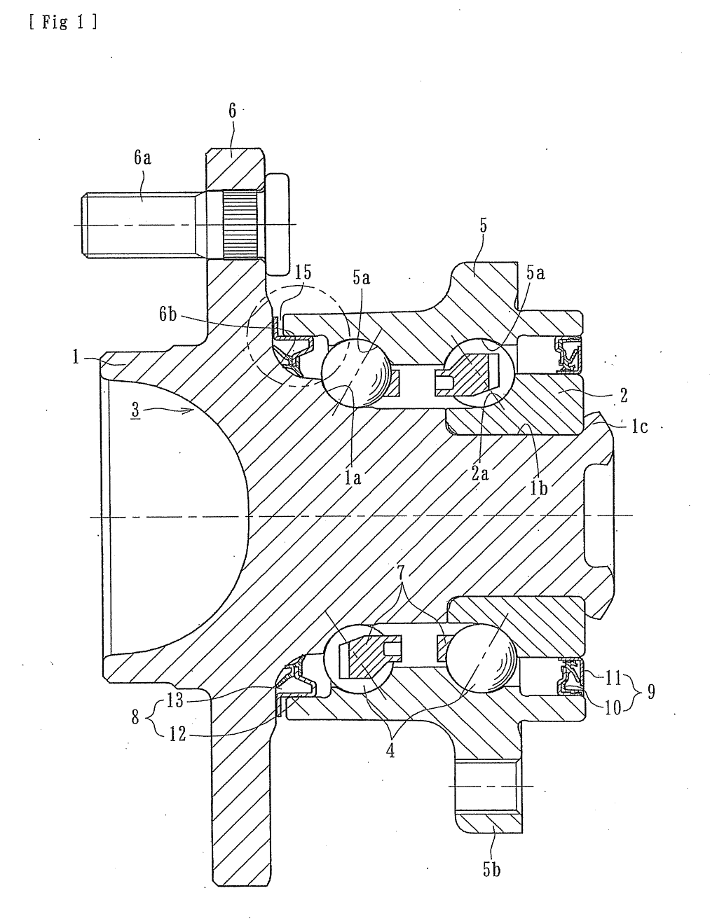

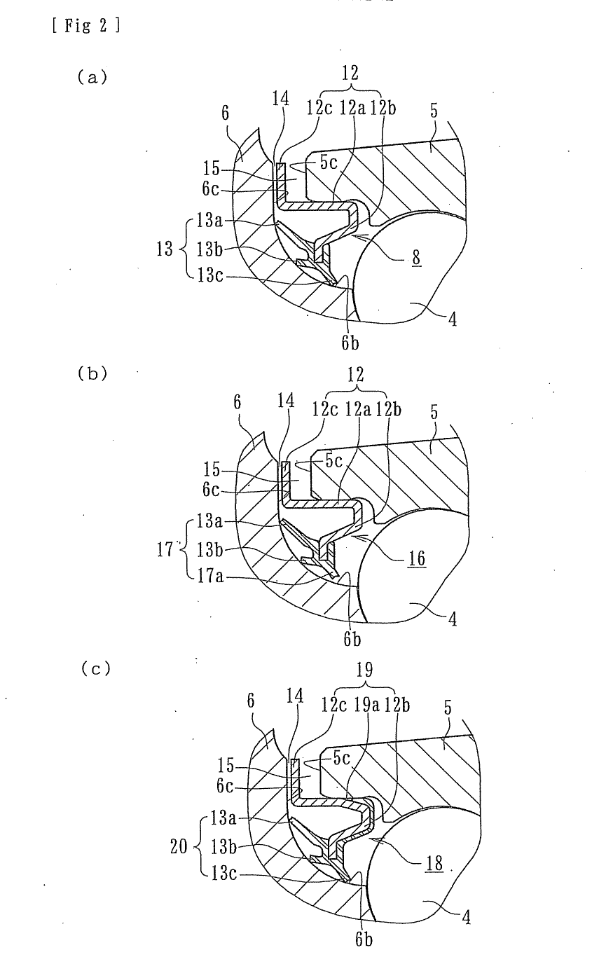

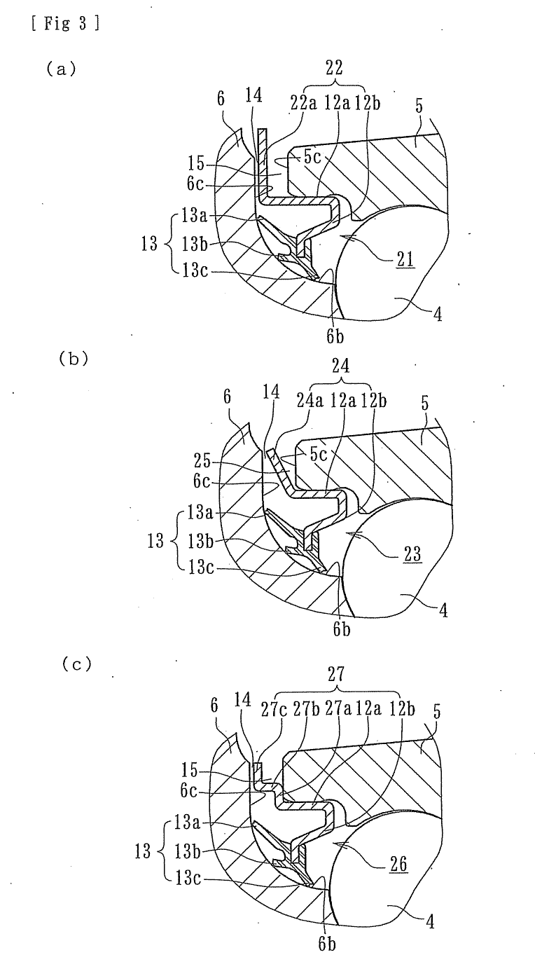

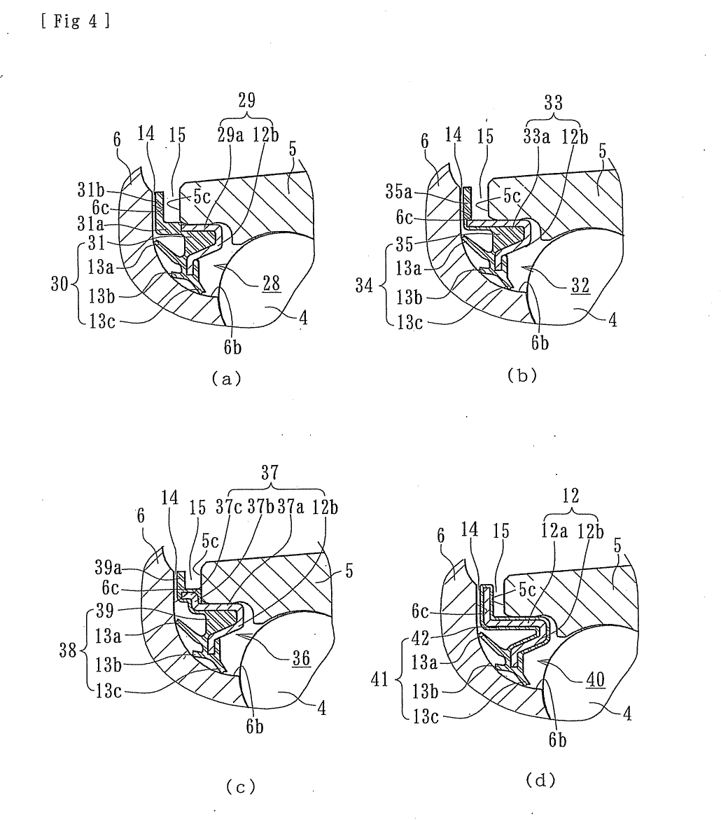

FIG. 1 is a longitudinal section view of a first embodiment of a vehicle wheel bearing apparatus. FIG. 2(a) is a partially enlarged view of an outer side seal of FIG. 1. FIG. 2(b) is a partially enlarged view of a modification of FIG. 2(a). FIG. 2(c) is a partially enlarged view of another modification of FIG. 2(a). FIGS. 3(a)-(c) are partially enlarged views with each showing another modification of FIG. 2(a). FIGS. 4(a)-(d) are partially enlarged views with each showing another modification of FIG. 2(a). In the descriptions of this specification, the term “outer-side” defines a side that is positioned outside of a vehicle body (left-hand side in drawings). The term “inner-side” defines a side that is positioned inside of a vehicle body (right-hand side in drawings) when the bearing apparatus is mounted on a vehicle.

The vehicle wheel bearing apparatus is a third generation type used for a driven wheel. It includes an inner member 3 with a wheel hub 1 and an inner ring 2 secured on the wheel hub 1. An outer member 5 is fit onto the inner member 3 via double row rolling elements (balls) 4, 4.

The wheel hub 1 is integrally formed with a wheel mounting flange 6 at its outer-side end. One (outer side) inner raceway surface 1a is formed on its outer circumference. A cylindrical portion 1b axially extends from the inner raceway surface 1a. Hub bolts 6a are arranged on the wheel mounting flange 6 equidistantly along its periphery.

The inner ring 2 is formed with the other (inner side) inner raceway surface 2a on its outer circumference. The inner ring 2 is press-fit onto the cylindrical portion 1b of the wheel hub 1, via a predetermined interference. The inner ring 2 is axially secured on the cylindrical portion 1b of the wheel hub 1 by a caulked portion 1c. The caulked portion is formed by plastically deforming the end of the cylindrical portion 1b under a predetermined pre-bearing pressure.

The wheel hub 1 is made of medium/high carbon steel including carbon of 0.40-0.80% by weight such as S53C. It is hardened by high frequency induction quenching so that a region from an inner-side base 6b of the wheel mounting flange 6, forming a seal land portion of the seal 8, to the cylindrical portion 1b, including the inner raceway surface 1a, is hardened to have surface hardness of HRC 58-64. The caulked portion 1c is not quenched and remains with an as is surface hardness after forging. On the other hand, the inner ring 2 and the rolling elements 4 are formed of high carbon chrome steel such as SUJ2. They are hardened to their core by dip quenching to have a surface hardness of HRC 58-64.

The outer member 5 is integrally formed with a body mounting flange 5b on its outer circumference. The body mounting flange 5b is to be, mounted on a knuckle (not shown) that forms part of the suspension apparatus of the vehicle. The outer member inner circumference includes double row outer raceway surfaces 5a, 5a that are opposite to the inner raceway surfaces 1a, 2a of the inner member 3. Double row balls 4, 4 are contained between the outer raceway surfaces 5a, 5a and inner raceway surfaces 1a, 2a of the inner member 3. The double row balls 4, 4 are rollably held by cages 7, 7.

The outer member 5 is made of medium/high carbon steel including carbon of 0.40-0.80% by weight such as S53C. At least surfaces of the double row outer raceway surfaces 5a, 5a are hardened by high frequency induction quenching to have a surface hardness of HRC 58-64. Seals 8, 9 are mounted within annular openings formed between the outer member 5 and the inner member 3. The seals 8, 9 prevent leakage of grease contained inside the bearing and the infiltration of rainwater or dust into the bearing from the outside.

An inner-side seal 9 of seals 8, 9 is formed as a so-called pack seal. It includes an annular sealing plate 10 press-fit, via a predetermined interference, into the inner-side end inner circumference of the outer member 5, forming a stator member. A slinger 11 is press-fit onto the outer circumference of the inner ring 2, forming a rotor member. The slinger is arranged opposite to the sealing plate 10. The outer-side seal 8 is formed as an integrated seal. It includes a metal core 12 press fit into the outer-side end inner circumference of the outer member 5, via a predetermined interference. A sealing member 13 is integrally adhered to the metal core 12 via vulcanized adhesion.

The metal core 12 is press-formed of steel sheet having corrosion resistance such as austenitic-stainless steel sheet (JIS SUS 304 etc.) or preserved cold rolled steel sheet (JIS SPCC etc.) and has an annular configuration. This suppresses the generation of corrosion on the metal core 12 and thus improves its durability and sealability for a long term.

The sealing member 13 is formed of synthetic rubber such as NBR (acrylonitrile-butadiene rubber). It is integrally adhered to the metal core 12 by vulcanizing adhesion. As shown in the enlarged view of FIG. 2(a), the sealing member 13 includes a side lip 13a, dust lip 13b and grease lip 13c. The side lip 13a is inclined radially outward. The dust lip 13b is inclined radially outward at a radially inner position from the side lip 13a. The grease lip 13c is inclined radially inward.

The inner-side base portion 6b of the wheel mounting flange 6 is formed with a surface of circular arc cross-section. The side lip 13a and the dust lip 13b slidably contact the surface via a predetermined axial interference. The grease lip 13c slidably contacts the surface, via a predetermined radial interference. Materials used for sealing member 13 other than NBR are e.g. HNBR (hydrogenated acrylonitrile-butadiene rubber), EPDM (ethylene propylene rubber) etc., having high heat resistance, as well as ACM (polyacrylic rubber), FKM (fluorinated rubber) or silicone rubber, having high heat resistance and chemical resistance.

A seal 8 of this embodiment has a metal core 12 with a cylindrical fitting portion 12a press-fit into the outer-side end inner circumference of the outer member 5. A radially inner portion 12b extends radially inward from the fitting portion 12a. The radially inner portion 12b is adhered with the sealing member 13. An annular disc-shaped weir portion (flange portion) 12c extends radially outward from the fitting portion 12a. The weir portion 12c opposes the inner-side surface 6c of the wheel mounting flange 6, via a small axial gap to form a labyrinth seal 14. The weir portion 12c also opposes the outer-side end face 5c of the outer member 5, via a predetermined axial gap, to form an annular discharging groove 15. Thus, it is possible to prevent the side lip 13a from being directly splashed with muddy water. In addition, the discharging groove 15 functions as a chute to guide muddy water downward to discharge it from the wheel bearing apparatus. Thus, even if the muddy water splashes over the outer circumference of the outer member 5 during running of the vehicle, it is possible to prevent muddy water from flowing through the gap between the wheel mounting flange 6 and the weir portion 12c. Thus, this improves the durability and sealability of the seal 8 for a long term.

A seal 16 shown in FIG. 2(b) is a modification of the seal 8 shown in FIG. 2(a). This seal 16 is only different from the seal 8 in the structure of sealing member. Thus, the same reference numerals are used to designate the same parts and their detailed description will be omitted.

The seal 16 is an integrated seal with the metal core 12 press-fit into the outer-side end inner circumference of the outer member 5. A sealing member 17 is adhered to the metal core 12. The sealing member 17 is formed of synthetic rubber such as NBR etc. and integrally adhered to the metal core 12 by vulcanizing adhesion. This sealing member 17 includes a radially outwardly inclined side lip 13. The dust lip 13b is also radially outward inclined at a radially inner position from the side lip 13a. A grease lip 17a is inclined toward the inner-side of the bearing.

The inner-side base portion 6b of the wheel mounting flange 6 has a surface with a circular arc cross-section. The side lip 13a and the dust lip 13b slidably contact the surface via a predetermined axial interference. The grease lip 17a is arranged opposite to the inner-side base portion 6b via a predetermined radial gap. Accordingly, since a labyrinth seal is formed between the grease lip 17a and the base portion 6b, it is possible to suppress the sliding resistance of the seal 16. Thus, this reduces the driving torque of the wheel bearing.

A seal 18 shown in FIG. 2(c) is another modification of the seal 8 shown in FIG. 2(a). The seal 18 is basically different from the seal 8 in the structure of metal core. Thus, the same reference numerals are used to designate the same parts and the detailed description will be omitted.

The seal 18 is an integrated seal with the metal core 19 press-fit into the outer-side end inner circumference of the outer member 5, via a predetermined interference. A sealing member 20 is adhered to the metal core 19.

The metal core 19 is press-formed from steel sheet having corrosion resistance such as austenitic-stainless steel sheet (JIS SUS 304 etc.) or preserved cold rolled steel sheet (JIS SPCC etc.). The metal core has an annular configuration with a cylindrical fitting portion 19a press-fit into the outer-side end inner circumference of the outer member 5. A radially inner portion 12b extends radially inward from the fitting portion 19a. An annular disc-shaped weir portion (flange portion) 12c extends radially outward from the fitting portion 19a.

The sealing member 20 is formed of synthetic rubber such as NBR and is integrally adhered to the metal core 19 by vulcanizing adhesion. The sealing member 20 extends over a region from the radially inner portion 12b to part of the fitting portion 19a. According to this modification, the sealing member 20 is arranged so that it extends over part of the fitting portion 19a. The sealability between the outer member 5 and the fitting portion 19a can be improved. Thus, infiltration of muddy water etc. from the outside to the inside of the bearing through the fitting portion can be prevented.

Seals 21, 23 and 26 shown in FIGS. 3(a)-(c) are other modifications of the seal 8 of FIG. 2(a). These seals are basically different from the seal 8 in structures of the seal and the weir portion of the metal core. Thus, the same reference numerals are used to designate the same parts and their detailed description will be omitted.

The seal 21 shown in FIG. 3(a) is an integrated seal with the metal core 22 press-fit into the outer-side end inner circumference of the outer member 5, via a predetermined interference. The sealing member 13 adheres to the metal core 22.

The metal core 22 is press-formed from steel sheet having corrosion resistance such as austenitic-stainless steel sheet (JIS SUS 304 etc.) or preserved cold rolled steel sheet (JIS SPCC etc.) and has an annular configuration. The cylindrical fitting portion 12a is press-fit into the outer-side end inner circumference of the outer member 5. The radially inner portion 12b extends radially inward from the fitting portion 12a. An annular disc-shaped weir portion 22a extends radially outward from the fitting portion 12a.

According to the modification of FIG. 3(a), the weir portion 22a is formed so that it has an outer diameter larger than that of the outer-side end outer circumference of the outer member 5. This enables the weir 22a to effectively perform its function as a weir. Thus, it more effectively prevent muddy water from flowing through the gap between the wheel mounting flange 6 and the weir portion 22a even if the muddy water splashes over the outer circumference of the outer member 5 during running of the vehicle. Accordingly, it is possible to improve the durability and sealability of the seal 21 for a long term.

The seal 23 shown in FIG. 3(b) is an integrated seal with the metal core 24 press-fit into the outer-side end inner circumference of the outer member 5, via a predetermined interference. The sealing member 13 adheres to the metal core 24.

The metal core 24 is press-formed from steel sheet having corrosion resistance such as austenitic-stainless steel sheet (JIS SUS 304 etc.) or preserved cold rolled steel sheet (JIS SPCC etc.) and has an annular configuration. The cylindrical fitting portion 12a is press-fit into the outer-side end inner circumference of the outer member 5. The radially inner portion 12b extends radially inward from the fitting portion 12a. A weir portion 24a is inclined toward the wheel mounting flange 6 extending from the fitting portion 12a. The well portion 24a is arranged opposite to the inner-side surface 6c of the wheel mounting flange 6, via a small axial gap, to form the labyrinth seal 14. In addition, the weir portion 24a is arranged opposite to the outer-side end face 5c of the outer member 5, via a predetermined axial gap, to form an annular discharging groove 25.

In this modification, the weir portion 24a is inclined toward the wheel mounting flange 6. The weir 24a can effectively perform its function as a weir. Thus, it more effectively prevents muddy water from flowing through the gap between the wheel mounting flange 6 and the weir portion 24a even if the muddy water splashes over the outer circumference of the outer member 5 during running of the vehicle. In addition, since the cross-section of the discharging groove 25 is substantially triangle, it is possible to effectively guide the muddy water, downward, splashed over the outer circumference of the outer member 5. Thus, this improves the durability and sealability of the seal 23 for a long term.

The seal 26 shown in FIG. 3(c) is an integrated seal with a metal core 27 press-fit into the outer-side end inner circumference of the outer member 5. via a predetermined interference. The sealing member 13 adheres to the metal core 27.

The metal core 27 is press-formed from steel sheet having corrosion resistance such as austenitic-stainless steel sheet (JIS SUS 304 etc.) or preserved cold rolled steel sheet (JIS SPCC etc.) and has an annular configuration. The cylindrical fitting portion 12a is press-fit into the outer-side end inner circumference of the outer member 5. The radially inner portion 12b extends radially inward from the fitting portion 12a. A flange portion 27a extends radially outward from the fitting portion 12a. The flange portion 27a is in close contact with the outer-side end face 5c of the outer member 5. A weir portion 27c extends radially outward from the flange portion 27a, via a cylindrical portion 27b. The weir portion 27c is arranged opposite to the inner-side surface 6c of the wheel mounting flange 6, via a small axial gap, to form the labyrinth seal 14. In addition, the weir portion 27c is arranged opposite to the outer-side end face 5c of the outer member 5, via a predetermined axial gap, to form an annular discharging groove 15.

According to this modification, the metal core 27 is formed with a stepped cross-section. The flange portion 27a contacts with the outer-side end face 5c of the outer member 5. The strength and rigidity of the metal core 27 itself can be increased. Thus, it is possible to prevent the metal core 27 from being deformed or damaged by impingement of pebbles etc. Also, it is possible to improve the positioning accuracy in the press-fitting step of the metal core 27 due to the presence of its flange portion 27a.

Seals 28, 32, 36 and 40 shown in FIGS. 4(a)-(d) are other modifications of the seal 8 of FIG. 2(a). These seals are basically different from the seal 8 in structure of the weir portion of the metal core. Thus, the same reference numerals are used to designate the same parts and their detailed description will be omitted.

The seal 28 shown in FIG. 4(a) is an integrated seal with a metal core 29 press-fit into the outer-side end inner circumference of the outer member 5, via a predetermined interference. A sealing member 30 adheres to the metal core 29.

The metal core 29 is press-formed from steel sheet having corrosion resistance such as austenitic-stainless steel sheet (JIS SUS 304 etc.) or preserved cold rolled steel sheet (JIS SPCC etc.) and has an annular configuration. A cylindrical fitting portion 29a is press-fit into the outer-side end inner circumference of the outer member 5. The radially inner portion 12b extends radially inward from the fifting portion 29a.

The sealing member 30 is formed of synthetic rubber such as NBR. The sealing member 30 includes the radially outwardly inclined side lip 13a. The dust lip 13b is also inclined radially outward at a radially inner position from the side lip 13a. The grease lip 13c is inclined toward the inner-side of the bearing. A seal base portion 31 covers over a region from the side lip 13a to the inner surface of the fitting portion 29a of the metal core 29. All of the sealing member parts are integrally formed and adhered to the metal core 29 by vulcanizing adhesion. In addition, a weir portion 31b extends radially outward and is continuously connected to the seal base portion 31 via a cylindrical portion 31a.

In this modification, the weir portion 31b is formed integrally with the sealing member 30. The weir portion 31b opposes the inner-side surface 6c of the wheel mounting flange 6, via a small axial gap, to form a labyrinth seal 14. The weir portion 31b also opposes the outer-side end face 5c of the outer member 5, via a predetermined axial gap, to form an annular discharging groove 15. Thus, it is possible to prevent the side lip 13a of the seal 28 from being directly splashed with muddy water. In addition, since the discharging groove 15 can guide muddy water downward to discharge it from the wheel bearing apparatus even if the muddy water splashes over the outer circumference of the outer member 5 during running of the vehicle. Thus, it is possible to prevent muddy water from flowing through the gap between the side surface 6c of the wheel mounting flange 6 and the weir portion 31b. Furthermore, the weir portion 31b is integrally formed with the sealing member 30 from elastic material. Thus, it is possible to prevent the weir portion 31b from being deformed or damaged by impingement of pebbles etc.

The seal 32 shown in FIG. 4(b) is an integrated seal with a metal core 33 press-fit into the outer-side end inner circumference of the outer member 5, via a predetermined interference. A sealing member 34 adheres to the metal core 33.

The metal core 33 is press-formed from steel sheet having corrosion, resistance such as austenitic-stainless steel sheet (JIS SUS 304 etc.) or preserved cold rolled steel sheet (JIS SPCC etc.) and has an annular configuration. A cylindrical fitting portion 33a is press-fit into the outer-side end inner circumference of the outer member 5. The radially inner portion 12b extends radially inward from the fitting portion 33a.

The sealing member 34 is formed of synthetic rubber such as NBR. The sealing member 34 includes the radially outwardly inclined side lip 13a. The dust lip 13b is also inclined radially outward at a radially inner position from the side lip 13a. The grease lip 13c is inclined toward the inner-side of the bearing. A seal base portion 35 covers over a region of the metal core 33 from the side lip 13a to the inner surface of the fitting portion 33a of the metal core 33. Thus, all of the sealing member parts are integrally formed and adheres to the metal core 33 by vulcanizing adhesion. In addition, a weir portion 35a extends radially outward and is continuously connected to the seal base portion 35.

In this modification, the weir portion 35a is integrally formed with the sealing member 34. The weir portion 35a opposes the inner-side surface 6c of the wheel mounting flange 6, via a small axial gap, to form a labyrinth seal 14. The weir portion 35a also opposes the outer-side end face 5c of the outer member 5, via a predetermined axial gap, to form an annular discharging groove 15. Thus, it is possible to prevent the side lip 13a of the seal 32 from being directly splashed with muddy water. In addition, the discharging groove 15 can guide muddy water downward to discharge it from the wheel bearing apparatus even if the muddy water splashes over the outer circumference of the outer member 5 during running of the vehicle. Thus, it is possible to prevent muddy water from flowing through the gap between the side surface 6c of the wheel mounting flange 6 and the weir portion 35a. Furthermore, the weir portion 35a is integrally formed with the sealing member 34 from elastic material. Thus, it is possible to prevent the weir portion 35a from being deformed or damaged by impingement of pebbles etc.

The seal 36 shown in FIG. 4(c) is an integrated seal with a metal core 37 press-fit into the outer-side end inner circumference of the outer member 5, via a predetermined interference. A sealing member 38 adheres to the metal core 37.

The metal core 37 is press-formed from steel sheet having corrosion resistance such as austenitic-stainless steel sheet (JIS SUS 304 etc.) or preserved cold rolled steel sheet (JIS SPCC etc.) and has an annular configuration. A cylindrical fitting portion 37a is press-fit into the outer-side end inner circumference of the outer member 5. The radially inner portion 12b extends radially inward from the fitting portion 37a. A flange portion 37b extends radially outward from the fitting portion 37a. A tongue portion 37c axially projects from the flange portion 37b.

The sealing member 38 is formed from synthetic rubber such as NBR. It includes the radially outwardly inclined side lip 13a. The dust lip 13b is also inclined radially outward at a radially inner position from the side lip 13a. The grease lip 13c is inclined toward the inner-side of the bearing. A seal base portion 39 covers a region of the metal core 37 from the side lip 13a to the external surfaces of the fitting portion 37a, flange portion 37b and tongue portion 37c of the metal core 37. All of the sealing member parts are integrally formed and adhered to the metal core 37 by vulcanizing adhesion. In addition, a weir portion 39a extends radially outward and is continuously connected to the seal base portion 39.

In this modification, the weir portion 39a is integrally formed with the sealing member 38. The weir portion 39a opposes the inner-side surface 6c of the wheel mounting flange 6, via a small axial gap, to form a labyrinth seal 14. The weir portion 39a also opposes the outer-side end face Sc of the outer member 5, via a predetermined axial gap, to form an annular discharging groove 15. Thus, it is possible to prevent the side lip 13a of the seal 36 from being directly splashed with muddy water. Furthermore, the weir portion 39a is integrally formed with the sealing member 38 from elastic material. Thus, it is possible to prevent the weir portion 39a from being deformed or damaged by impingement of pebbles etc. In addition, since the exposed external surfaces of the flange portion 37b and the tongue portion 37c of the metal core 37 are covered by the elastic member forming the sealing member 38, the sealability of the mating portion between the metal core 37 and the outer member 5 is improved.

The seal 40 shown in FIG. 4(d) is an integrated seal with the metal core 12 press-fit into the outer-side end inner circumference of the outer member 5, via a predetermined interference. A sealing member 41 adheres to the metal core 12.

The sealing member 41 is formed of synthetic rubber such as NBR. The sealing member includes the radially outwardly inclined side lip 13a. The dust lip 13b is also inclined radially outward at a radially inner position from the side lip 13a. The grease lip 13c is inclined toward the inner-side of the bearing. A covering portion 42 is formed on the whole external surface of the metal core 12.

In this modification, the whole external surface of the metal core 12 is covered by the sealing member 41 formed of elastic material. Thus, it is possible to improve the sealability of the mating portion between the metal core 12 and the outer member 5. In addition, it is possible to suppress corrosion of the metal core 12 without using expensive stainless steel as the metal core 12 and to reduce the manufacturing cost by using cold rolled steel sheet with a lower cost and high workability.

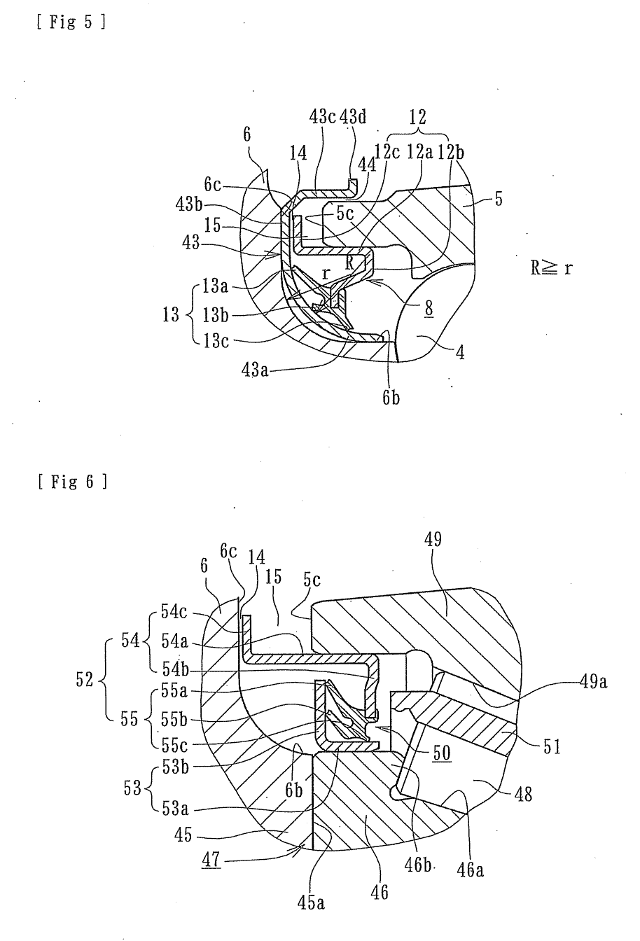

FIG. 5 is a longitudinal section view of a second embodiment of the vehicle wheel bearing apparatus. This embodiment is basically only different from the first embodiment (FIG. 2) in an addition of an annular metal member. Thus, the same reference numerals are used to designate the same parts and their detailed description will be omitted.

The seal 8 is an integrated seal with the metal core 12 press-fit into the outer-side end inner circumference of the outer member 5, via a predetermined interference. A sealing member 13 adheres to the metal core 12. The sealing member 13 includes the radially outwardly inclined side lip 13a. The dust lip 13b is also inclined radially outward at a radially inner position from the side lip 13a. The grease lip 13c is inclined toward the inner-side of the bearing. All lips are integrally formed and adhered to the metal core 12 by vulcanizing adhesion.

According to the second embodiment, the side lip 13a, the dust lip 13b and the grease lip 13c are adapted to be in sliding contact with an annular metal member 43. The annular metal member 43 is fit onto the inner-side base portion 6b of the wheel mounting flange 6. The annular metal member 43 is press-formed from a steel sheet having corrosion resistance such as austenitic-stainless steel sheet (JIS SUS 304 etc.) or preserved cold rolled steel sheet (JIS SPCC etc.) and has an annular configuration. A curved portion 43a is formed with a circular arc cross-section that corresponds to the curved surface of the inner-side base portion 6b of the wheel mounting flange 6. An annular disc-shaped portion 43b is adapted to be in close contact with the inner-side surface 6c of the wheel mounting flange 6. A cylindrical ceiling portion 43c axially extends toward a direction away from the wheel mounting flange 6. A bent portion 43d extends radially outward from the ceiling portion 43c.

The ceiling portion 43c is arranged opposite to the outer-side end outer circumference of the outer member 5, via a small radial gap, to form a labyrinth seal 44. The provision of the labyrinth seal 44 and the weir portion 12c of the metal core 12 makes it possible to prevent infiltration of muddy water into the slidably contacted portion between the seal 8 and the annular metal member 43. In addition, muddy water flows downward and is discharged through the discharging groove 15 even if the muddy water splashes over the outer circumference of the outer member during running of the vehicle. Thus, it is possible to improve the durability and sealability of the seal for a long term. Furthermore, the provision of the bent portion 43d improves the rigidity of the ceiling portion 43c. Thus, this prevents the deformation or damage caused by impingement of pebbles etc.

The annular metal member 43 is formed from a steel sheet that has the surface roughness of Ra 0.2-0.6. This makes it possible to obtain a good slidably contacting surface and thus to maintain the sealing performance of the seal while suppressing lip wear even if the wheel bearing apparatus is used in severe circumstances. In this case, “Ra” is one of the geometric parameters of JIS (JIS B0601-1994) and means the arithmetic average of the roughness, i.e. the average of absolute value deviations from the average line.

The base portion 6b includes a surface with a circular arc-shaped cross-section of a predetermined radius of curvature “r”. The curved portion 43a of the annular metal member 43 has a circular arc cross-section of a predetermined radius of curvature “R”. Each radius of curvature “R” and “r” is set so that there is a relationship R≧r. This makes it possible to prevent the annular metal member 43 from rising from the circular arc surface of the base portion 6b due to interference of the curved portion 43a of the annular metal member 43 with the circular arc surface of the base portion 6b when the annular metal member 43 is fit onto the base portion 6b. Thus, a gap is formed between the side surface 6c of the wheel mounting flange 6 and the annular disc-shaped portion 43b. Accordingly, the annular metal member 43 is in close contact with the side surface 6c of the wheel mounting flange 6. Thus, variation of interference of each lip can be suppressed to assure stable sealability.

FIG. 6 is a longitudinal section view of a third embodiment of a vehicle wheel bearing apparatus. This vehicle wheel bearing apparatus is a second generation type used for a driving wheel. It includes an inner member 47 with a wheel hub 45 and a pair of inner rings 46 press-fit onto the wheel hub 45. An outer member 49 is fit onto the inner member 47, via double row rolling elements (tapered rollers) 48, 48. A seal 50 is mounted within an outer-side annular opening formed between the outer member 49 and the inner member 47. The seal prevents leakage of grease contained in the bearing and the infiltration of rainwater or dust into the bearing from the outside.

The wheel hub 45 is integrally formed with a wheel mounting flange 6 at its outer-side end. A cylindrical portion (not shown) axially extends from the wheel mounting flange 6. The pair of inner rings 46, 46 is press-fit onto the cylindrical portion. Each inner ring 46 is formed on its outer circumference with a tapered inner raceway surface 46a. A cone back face rib 46b, for guiding the rolling elements 48, is formed on a larger diameter side of the inner raceway surface 46a.

The wheel hub 45 is made of medium/high carbon steel including carbon of 0.40-0.80% by weight such as S53C. It is hardened by high frequency induction quenching so that a region from an inner-side base 6b of the wheel mounting flange 6 to the cylindrical portion through a shoulder portion 45a is hardened to have a surface hardness of HRC 50-64. The inner rings 46 and the rolling elements 48 are formed of high carbon chrome steel such as SUJ2. They are hardened to their core by dip quenching to have a surface hardness of HRC 58-64.

The outer member 49 is integrally formed with a body mounting flange (not shown) on its outer circumference. The outer member inner circumference includes double row outer raceway surfaces 49a, 49a opposite to the inner raceway surfaces 46a, 46a of the inner rings 46, 46. Double row rolling elements 48, 48 are contained between the outer raceway surfaces 49a, 49a and inner raceway surfaces 46a, 46a. The rollers are rollably held by cages 51, 51.

The outer member 49 is made of medium/high carbon steel including carbon of 0.40-0.80% by weight such as S53C. At least the double row outer raceway surfaces 49a, 49a are hardened by high frequency induction quenching to have a surface hardness of HRC 58-64.

The outer-side seal 50 is formed as a so-called pack seal. It includes an annular sealing plate 52 press-fit into the outer-side end inner circumference of the outer member 49. A slinger 53 is press-fit onto the inner ring 46. The sealing plate 52 and slinger 53 are arranged opposite to each other.

The sealing plate 52 includes a metal core 54 and a sealing member 55 integrally adhered to the metal core 54 by vulcanized adhesion. The metal core 54 is press-formed from a steel sheet with corrosion resistance such as austenitic-stainless steel sheet (JIS SUS 304 etc.) or preserved cold rolled steel sheet (JIS SPCC etc.) and has a substantially crank-shaped cross-section. A cylindrical fitting portion 54a is press-fit onto the outer member 49. A radially inner portion 54b extends radially inward from the fitting portion 54a. An annular disc-shaped weir portion 54c extends radially outward from the fitting portion 54a. The sealing member 55 is formed of synthetic rubber such as NBR. It includes a pair of radially outwardly inclined side lips 55a, 55b. A grease lip 55c is inclined radially inward.

The slinger 53 is press-formed of steel sheet having corrosion resistance such as ferritic-stainless steel sheet (JIS SUS 430 etc.), austenitic-stainless steel sheet (JIS SUS 304 etc.) or preserved cold rolled steel sheet (JIS SPCC etc.) and has a substantially L-shaped cross-section. A cylindrical fitting portion 53a is press-fit onto the outer circumference of the inner ring 46, via a predetermined interference. A standing portion 53b extends radially outward from the fitting portion 53a. The side lips 55a, 55b slidably contact the standing portion 53b of the slinger 53, via an axial interference. The grease lip 55c slidably contacts the fitting portion 53a via a predetermined radial interference.

In this embodiment, the weir portion 54c of the metal core 54 opposes the inner-side surface 6c of the wheel mounting flange 6, via a small axial gap, to form a labyrinth seal 14. The weir portion 54c also opposes the outer-side end face 5c of the outer member 49, via a predetermined axial gap, to form an annular discharging groove 15. Thus, it is possible to prevent the side lip 55a of the seal 50 from being directly splashed with muddy water. In addition, the discharging groove 15 can guide muddy water downward to discharge it from the wheel bearing apparatus even if the muddy water splashes over the outer circumference of the outer member 49 during running of the vehicle. Thus, it is possible to improve the durability and sealability of the seal 50 for a long term.

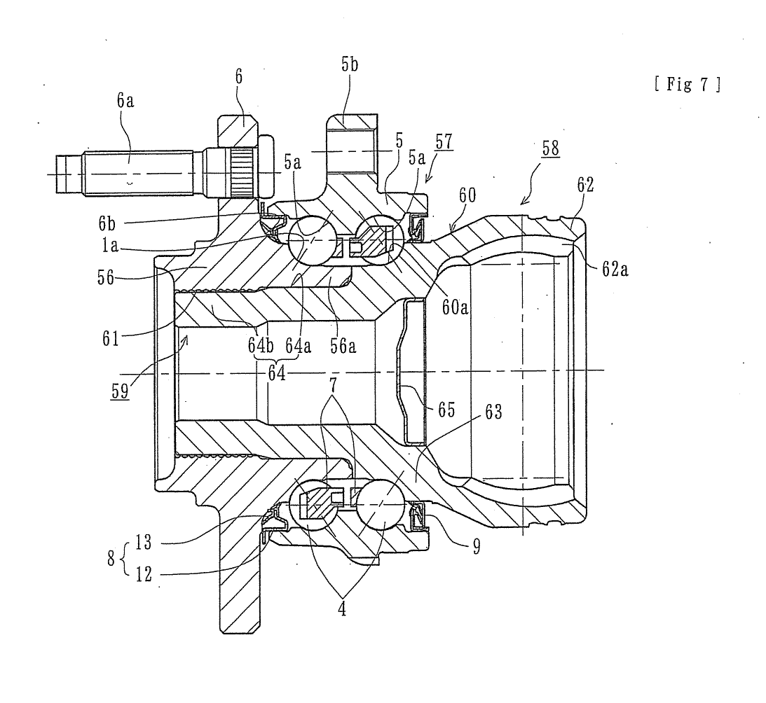

FIG. 7 is a longitudinal section view of a fourth embodiment of a vehicle wheel bearing apparatus. This embodiment is basically only different from the previous embodiments in the structure of the bearing portion. Thus, the same reference numerals are used to designate the same parts and their detailed description will be omitted.

This wheel bearing apparatus structure is a so-called fourth generation type where a wheel hub 56, a double row rolling bearing 57, and a constant velocity universal joint 58 are united. The wheel hub 56 is integrally formed with the wheel mounting flange 6 at the outer-side end. The wheel hub outer circumstance includes one (outer-side) inner raceway surface 1a. A cylindrical portion 56a extends axially from the inner raceway surface.

The double row rolling bearing 57 mainly comprises the outer member 5, inner member 59 and the double row rolling elements 4, 4. The inner member 59 includes the wheel hub 56 and an outer joint member 60. The inner member 59 is formed with double row inner raceway surfaces 1a, 60a opposite to the outer raceway surfaces 5a, 5a of the outer member 5. One (outer-side) inner raceway surface 1a is formed on the outer circumference of the wheel hub 56. The other (inner-side) inner raceway surface 60a is formed on the outer circumference of the outer joint member. The double row rolling elements 4, 4 are contained between the inner and outer raceway surfaces. The rolling elements are rollably held therein by cages 7, 7. Seals 8, 9 are mounted within annular openings formed between the outer member 5 and the inner member 59. The seals 8, 9 prevent leakage of grease contained in the bearing and the infiltration of rainwater or dust into the bearing from the outside.

The wheel hub 56 is made of medium/high carbon steel including carbon of 0.40-0.80% by weight such as S53C. It is hardened by high frequency induction quenching so that a region from a seal land portion (base portion 6b of the wheel mounting flange 6) of the outer-side seal 8 to the cylindrical portion 56a is hardened to have a surface hardness of HRC 58-64. This not only improves the wear resistance of the seal land portion but the mechanical strength and durability of the wheel hub 56 against rotary bending loads applied to the wheel mounting flange 6.

The inner circumference of the wheel hub 56 is formed with an irregular portion 61 hardened by high frequency induction heating to have a surface hardness of HRC 54-64. The irregular portion 61 is formed with a crisscross pattern knurl formed by combining a plurality of independent annular groove, formed by e.g. a lathe, and a plurality of axial grooves, formed by e.g. broaching as orthogonally crossed grooves, or mutually inclined helical grooves. Each projection forming the irregular portion 61 may have a pointed pyramid-like configuration to increase the biting ability of the irregular portion 61.

The constant velocity universal joint 58 includes an outer joint member 60, a joint inner ring (not shown), cage and torque transmitting balls (not shown). The outer joint member 60 has a cup-shaped mouth portion 62, a shoulder portion 63, forming the bottom of the mouth portion 62, and a hollow shaft portion 64 that axially extends from the shoulder portion 63. Axially extending curved track grooves 62a are formed on the inner circumference of the mouth portion 62. The shaft portion 64 is formed, on its outer circumference, with a spigot portion 64a fit into the cylindrical portion 56a of the wheel hub 56, via a predetermined radial gap. A fitting portion 64b extends from the spigot portion 64a to the end of the shaft portion 64. An end cap 65 is fit into the inner circumference of the shoulder portion 63 to prevent leakage of lubricating grease sealed in the inside of the joint and the infiltration of rain water or dust from the outside to the inside of the joint.

The wheel hub 56 and the outer joint member 60 are integrally connected through plastic deformation by inserting the shaft portion 64 into the wheel hub 56 until the shoulder portion 63 of the outer joint member 60 abuts against the end face of the cylindrical portion 56a of the wheel hub 56. An expanding tool, such as a mandrel, is inserted into a bore of the fitting portion 64b. The material of fitting portion 64b is forced into the hardened irregular portion 61 so that the pointed projections of the irregular portion 61 of the wheel hub 56 bite into the material of the fitting portion 64b of the outer joint member 60. This eliminates the necessity of adjustment of pre-load applied by fastening a nut (not shown) conventionally performed in the prior art. Thus, it is possible to reduce the size and weight of the wheel hub 56 and to maintain the pre-load for a long term.

Similar to the first embodiment, the metal core 12 of this embodiment has the annular disc-shaped weir portion 12c extending radially outward. The weir portion 12c opposes the inner-side surface 6c of the wheel mounting flange 6, via a small axial gap, to form the labyrinth seal 14. The weir portion 12c also opposes the outer-side end face 5c of the outer member 5, via a predetermined axial gap, to form the annular discharging groove 15. Thus, it is possible to prevent the side lip 13a of the seal 8 from being directly splashed with muddy water. In addition, the discharging groove 15 can guide muddy water downward to discharge it from the wheel bearing apparatus even if the muddy water splashes over the outer circumference of the outer member 5 during running of the vehicle. Thus, it is possible to prevent muddy water from flowing through the gap between the side surface 6c of the wheel mounting flange 6 and the weir portion 12c. This improves the durability and sealability of the seal 8 for a long term.

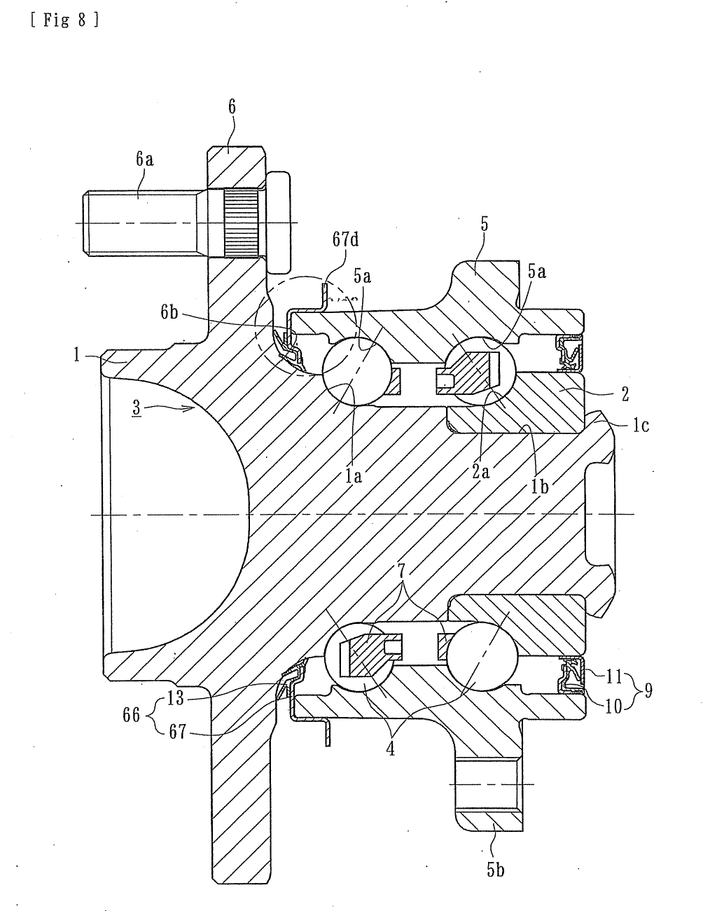

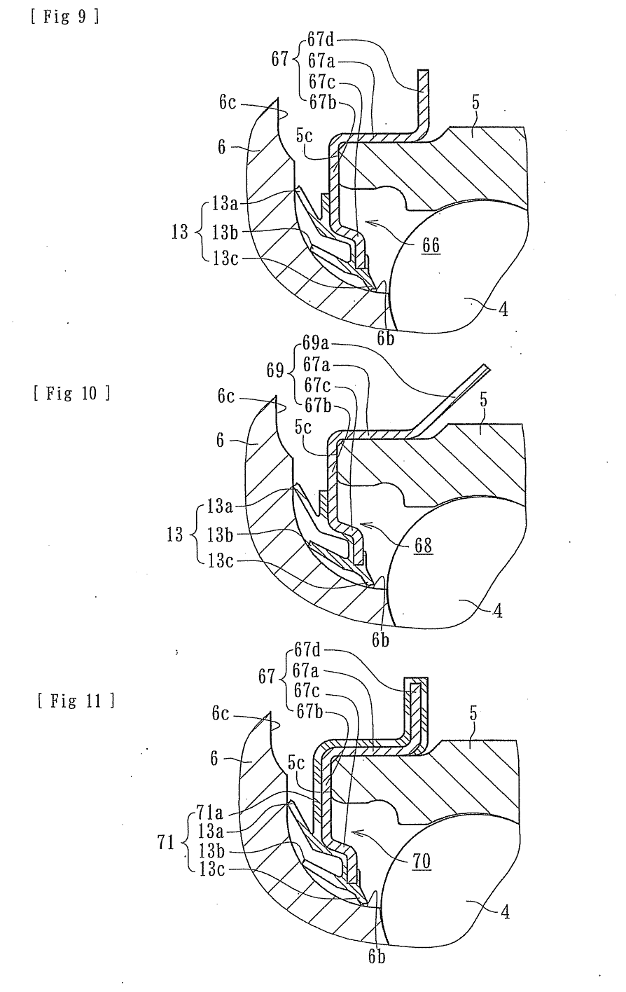

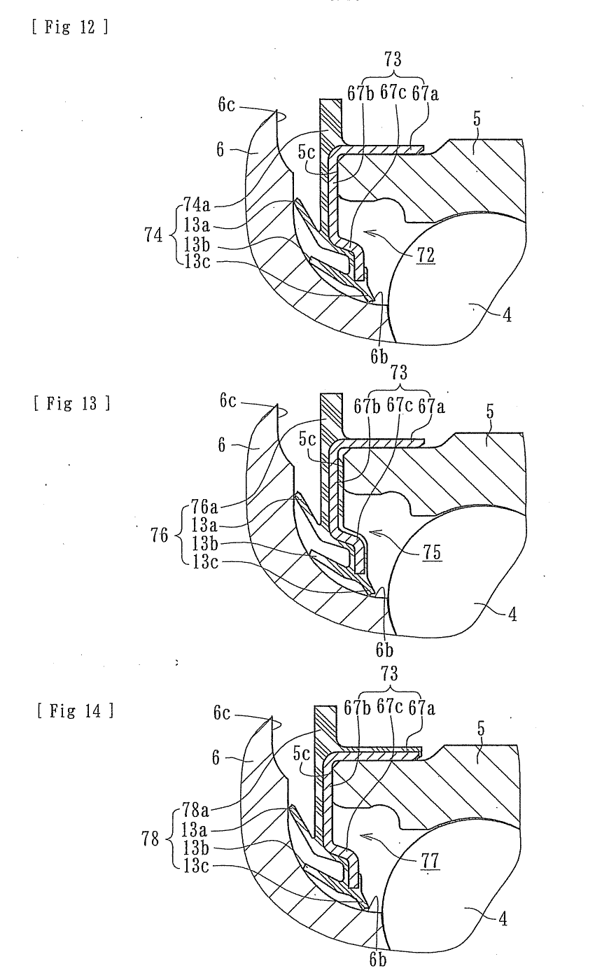

FIG. 8 is a longitudinal section view of a fifth embodiment of a vehicle wheel bearing apparatus. FIG. 9 is a partially enlarged view of an outer side seal of FIG. 8. FIG. 10 is a partially enlarged view of a modification of FIG. 9. FIG. 11 is a partially enlarged view of another modification of FIG. 9. FIG. 12 is a partially enlarged view of another modification of FIG. 9. FIG. 13 is a partially enlarged view of a modification of FIG. 12. FIG. 14 is a partially enlarged view of another modification of FIG. 12. This embodiment is basically only different from the first embodiment (FIG. 1) in the structure of the outer-side seal. Thus, the same reference numerals are used to designate the same parts and their detailed description will be omitted.

This vehicle wheel bearing apparatus is a third generation type used for a driven wheel. It includes an inner member 3 with a wheel hub 1 and an inner ring 2 secured on the wheel hub 1. An outer member 5 is fit onto the inner member 3 via double row rolling elements 4, 4.

Seals 66, 9 are mounted within annular openings formed between the outer member 5 and the inner member 3. The seals 66, 9 prevent leakage of grease contained in the bearing and the infiltration of rainwater or dust into the bearing from the outside.

The outer-side seal 66 is formed as an integrated seal with a metal core 67 press fit into the outer-side end outer circumference of the outer member 5. A sealing member 13 is integrally adhered to the metal core 67 via vulcanized adhesion. The metal core 67 of the seal 66 is press-formed from a steel sheet with corrosion resistance such as austenitic-stainless steel sheet (JIS SUS 304 etc.) or preserved cold rolled steel sheet (JIS SPCC etc.) and has, in general, an annular configuration. This suppresses the generation of corrosion on the metal core 67 and improves its durability and sealability for a long term.

As shown in the enlarged view of FIG. 9, the metal core 67 of the seal 66 of this embodiment has a cylindrical fitting portion 67a press-fit onto the outer-side end outer circumference of the outer member 5. A flange portion 67b extends radially inward from the fitting portion 67a. The flange portion 67b is in close contact with the outer-side end face 5c of the outer member 5. A radially inner portion 67c is bent inboard side and then extends radially inward from the flange portion 67b. An annular disc-shaped weir portion 67d extends radially outward from the fitting portion 67a. Such a metal core 67 with a bent configuration increases its strength and rigidity. Thus, this prevents plastic deformation of the weir portion 67d of the metal core 67 and its interference with other parts. In addition, the weir portion 67d can effectively prevent muddy water from flowing through the gap between the side surface 6c of the wheel mounting flange 6 and the weir portion 67d even if the muddy water splashes over the outer circumference of the outer member 5 during running of the vehicle. Thus, it is possible to improve the durability and sealability of the seal 66 for a long term.

A seal 68 shown in FIG. 10 is a modification of the seal 66 shown in FIG. 9. This seal 68 is only different from the seal 66 in the structure of the metal core of the seal. Thus, the same reference numerals are used to designate the same parts and their detailed description will be omitted.

The seal 68 is an integrated seal with the metal core 69 press-fit onto the outer-side end outer circumference of the outer member 5. A sealing member 13 is adhered to the metal core 69. The metal core 69 is press-formed from a steel sheet having corrosion resistance such as austenitic-stainless steel sheet (JIS SUS 304 etc.) or preserved cold rolled steel sheet (JIS SPCC etc.) and has an annular configuration. A fitting portion 67a is press-fit into the outer-side end outer circumference of the outer member 5. A flange portion 67b extends radially inward from the fitting portion 67a. The flange portion 67b is in close contact with the outer-side end face 5c of the outer member 5. A radially inner portion 67c is bent and then further extends radially inward from the flange portion 67b. An annular disc-shaped weir portion 69a is inclined radially outward toward the inner-side from the fitting portion 67a. The weir portion 69a contributes to further prevent muddy water from flowing into a space between the metal core 69 and the side surface 6c of the wheel mounting flange 6 with flowing over the outer circumference of the outer member 5 even if the muddy water splashes over the outer circumference of the outer member 5 during running of the vehicle.

A seal 70 shown in FIG. 11 is another modification of the seal 66 shown in FIG. 9. The seal 70 is only different from the seal 66 in the structure of the sealing member of the seal. Thus, the same reference numerals are used to designate the same parts and the detailed description will be omitted.

The seal 70 includes the metal core 67 press-fit onto the outer-side end outer circumference of the outer member 5. A sealing member 71 is adhered to the metal core 67. The sealing member 71 is formed of synthetic rubber such as NBR and adhered to the metal core 67 by vulcanizing adhesion. The sealing member 71 includes the radially outwardly inclined side lip 13a. The dust lip 13b is also inclined radially outward at a radially inner position from the side lip 13a. The grease lip 13c is inclined toward the inner-side of the bearing. A covering portion 71a covers an exposed surface of the metal core 67. All sealing member parts are integrally formed.

In this modification, since the sealing member 70 has a covering portion 71a to cover an exposed surface of the metal core, it is possible to prevent infiltration of muddy water through the fitting portion between the fitting portion 67a of the metal core and the outer member 5. This improves the sealability and suppresses the corrosion of the metal core without using expensive stainless steel as the metal core and thus reduces the manufacturing cost by using cold rolled steel sheet of lower cost and high workability.

A seal 72 shown in FIG. 12 is another modification of the seal 66 shown in FIG. 9. The same reference numerals are used to designate the same parts and their detailed description will be omitted. The seal 72 includes the metal core 73 press-fit onto the outer-side end outer circumference of the outer member 5. A sealing member 74 is adhered to the metal core 73.

The metal core 73 is press-formed from a steel sheet with corrosion resistance such as austenitic-stainless steel sheet (JIS SUS 304 etc.) or preserved cold rolled steel sheet (JIS SPCC etc.) and has an annular configuration. The fitting portion 67a is press-fit into the outer-side end outer circumference of the outer member 5. A flange portion 67b extends radially inward from the fitting portion 67a. The flange portion 67b is in close contact with the outer-side end face 5c of the outer member 5. A radially inner portion 67c is bent and then further extends radially inward from the flange portion 67b. All portions are integrally formed.

The sealing member 74 is formed of synthetic rubber such as NBR and adhered to the metal core 73 by vulcanizing adhesion. The sealing member 74 includes the radially outwardly inclined side lip 13a. The dust lip 13b is also inclined radially outward at a radially inner position from the side lip 13a. The grease lip 13c is inclined toward the inner-side of the bearing. A weir portion 74a covers a region from a root of the side lip 13a to the flange portion 67b of the metal core 73 and projects radially outward from the fitting portion 67a. All sealing member parts are integrally formed. According to this modification, the weir portion 74a is integrally formed with the sealing member 74. Thus, it is possible to prevent the weir portion 74a from interfering with other parts during assembly of the bearing and from being damaged by pebbles etc. during running of the vehicle. Also, the weir portion 74a prevents muddy water from flowing through the gap between the side surface 6c of the wheel mounting flange 6 and the weir portion 74a even if the muddy water splashes over the outer circumference of the outer member 5 during running of the vehicle.

A seal 75 shown in FIG. 13 is a modification of the seal 72 shown in FIG. 12. The seal 75 is only different from the seal 72 in the structure of the sealing member of the seal. Thus, the same reference numerals are used to designate the same parts and their detailed description will be omitted.

This seal 75 includes the metal core 73 press-fit onto the outer-side end outer circumference of the outer member 5. A sealing member 76 is adhered to the metal core 73. The sealing member 76 is formed of synthetic rubber such as NBR and is adhered to the metal core 73 by vulcanizing adhesion. The sealing member 76 includes the radially outwardly inclined side lip 13a. The dust lip 13b is also inclined radially outward at a radially inner position from the side lip 13a. The grease lip 13c is inclined toward the inner-side of the bearing. A weir portion 76a covers a region from a root of the grease lip 13c to both sides of the flange portion 67b of the metal core 73 and projects radially outward from the fitting portion 67a. All sealing member parts are integrally formed. According to this modification, the weir portion 76a, covering both sides of the flange portion 67b of the metal core 73, is integrally formed with the sealing member 76. Thus, it is possible to prevent the weir portion 76a from interfering with other parts during assembly of the bearing and from being damaged by pebbles etc. during running of the vehicle. Also, the weir portion 76a prevents infiltration of muddy water through the portion between the flange portion 67b of the metal core 73 and the end face 5c of the outer member 5. This improves the sealability and prevents leakage of grease contained in the bearing.

A seal 77 shown in FIG. 14 is a modification of the seal 72 shown in FIG. 12. The seal 77 is only different from the seal 72 in the structure of the sealing member of the seal. Thus, the same reference numerals are used to designate the same parts and their detailed description will be omitted.

This seal 77 includes the metal core 73 press-fit onto the outer-side end outer circumference of the outer member 5. A sealing member 78 is adhered to the metal core 73.

The sealing member 78 is formed of synthetic rubber such as NBR and is adhered to the metal core 73 by vulcanizing adhesion. The sealing member 78 includes the radially outwardly inclined side lip 13a. The dust lip 13b is also inclined radially outward at a radially inner position from the side lip 13a. The grease lip 13c is inclined toward the inner-side of the bearing. A weir portion 78a, covering a region from a root of the side lip 13a to the fitting portion 67a of the metal core 73, projects radially outward from the fitting portion 67a. All of the sealing member parts are integrally formed.

According to this modification, the weir portion 78a, covering the fitting portion 67a of the metal core 73 and projecting radially outward from the end of the fitting portion 67a, is integrally formed with the sealing member 78. Thus, it is possible to prevent the weir portion 78a from interfering with parts during assembly of the bearing and from being damaged by pebbles etc. during running of the vehicle. Also, the weir portion 78a suppresses corrosion of the metal core 73 without using expensive stainless steel as the metal core 73. Thus, this reduces manufacturing costs by using cold rolled steel sheet with a low cost and high workability.

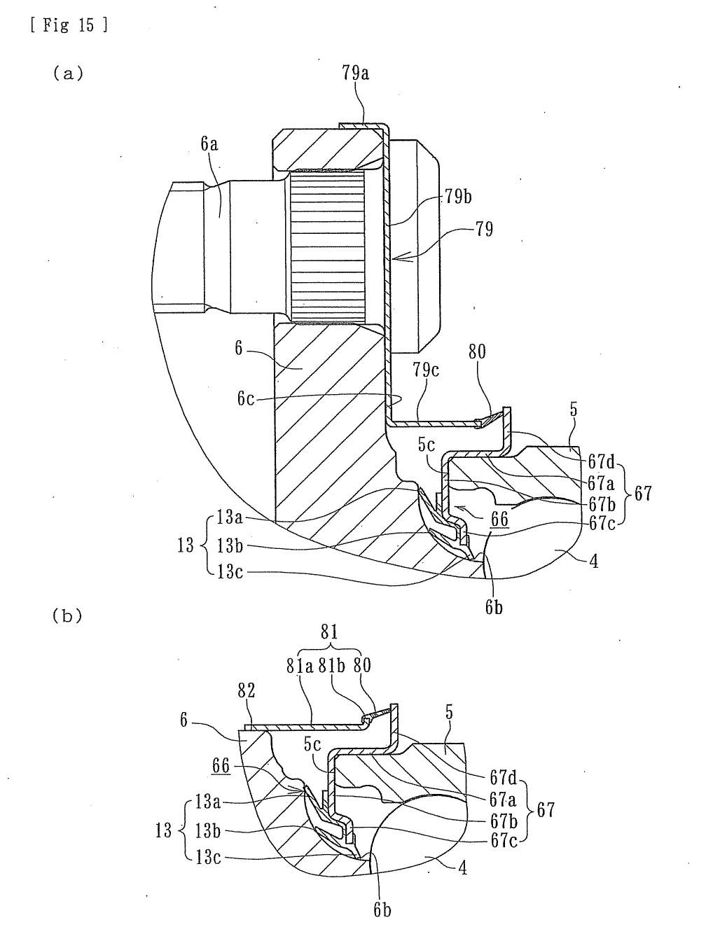

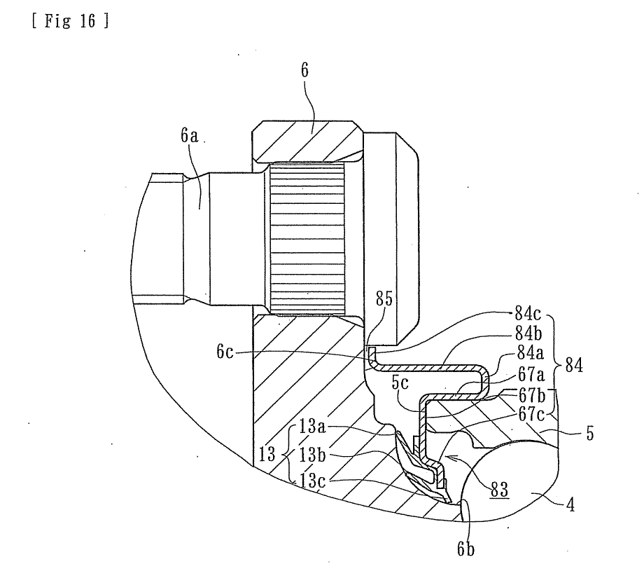

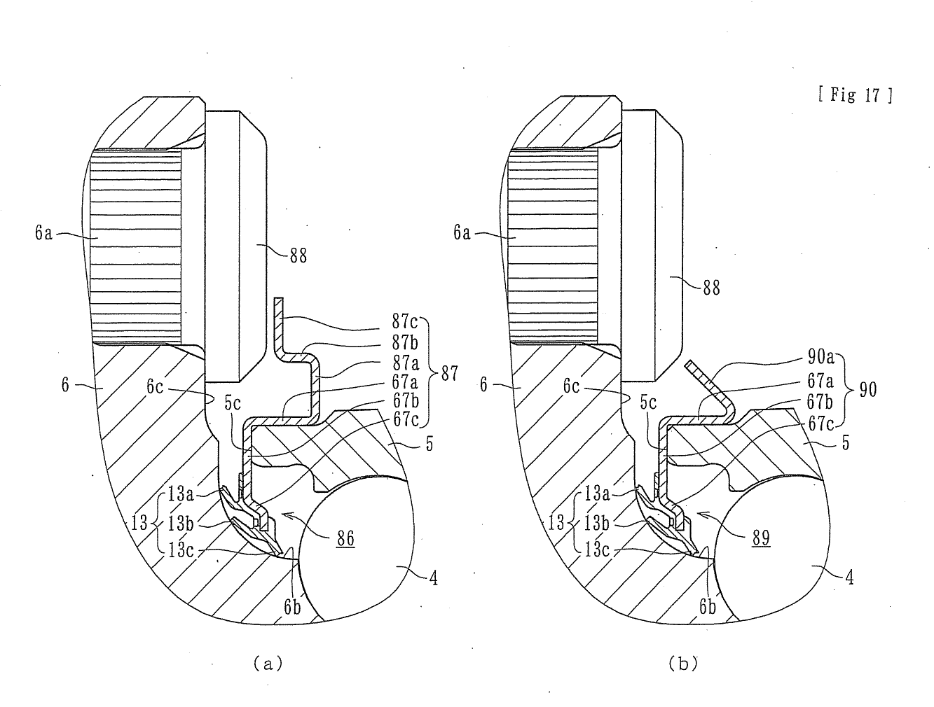

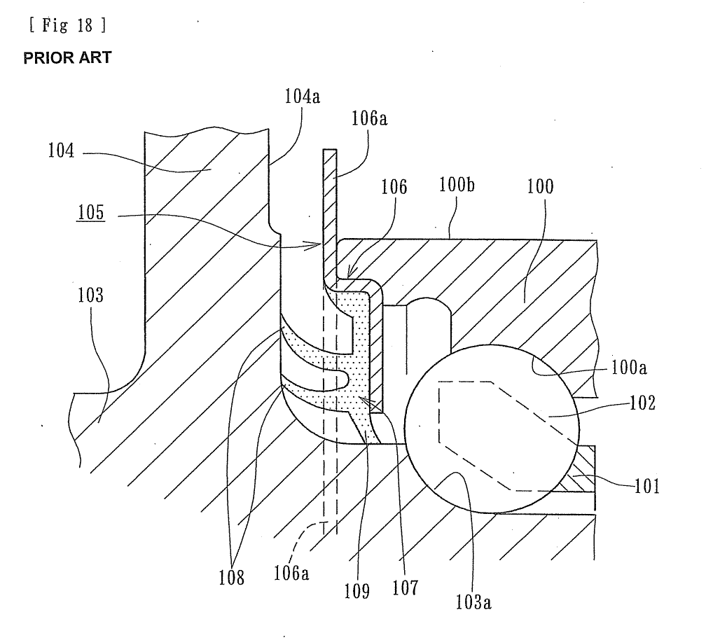

FIG. 15(a) is a longitudinal section view of a sixth embodiment of a vehicle wheel bearing apparatus. FIG. 15(b) is a partially enlarged view of a modification of FIG. 15(a). FIG. 16 is a partially enlarged view of another modification of FIG. 15(a). FIG. 17(a) and FIG. 17 (b) are partially enlarged views with each showing a modification of FIG. 16. This embodiment is only different from the fifth embodiment (FIG. 8) in the structure of the seal. Thus, the same reference numerals are used to designate the same parts and their detailed description will be omitted.

The outer-side seal 66 includes the metal core 67 press-fit onto the outer-side end outer circumference of the outer member 5. A sealing member 13 is adhered to the metal core 67.

This embodiment has an outside seal 79 in addition to the seal 66. The outside seal 79 is secured to the wheel mounting flange 6 by hub bolts 6a. The outside seal 79 is press-formed from a steel sheet with corrosion resistance such as austenitic-stainless steel sheet (JIS SUS 304 etc.) or preserved cold rolled steel sheet (JIS SPCC etc.). A cylindrical fitting portion 79a is press-fit onto the outer circumference of the wheel mounting flange 6. An annular disc-shaped portion 79b extends radially inward from the fitting portion 79a. The disc-shaped portion 79b is in close contact with an inner-side surface 6c of the wheel mounting flange 6. A cylindrical overhang portion 79c is bent toward an axially inner-side from the annular disc-shaped portion 79b. A side lip 80 of synthetic rubber such as NBR is integrally adhered to the overhang portion 79c, by vulcanizing adhesion. The side lip 80 slidably contacts the side surface of the weir portion 67d of the metal core 67, via a predetermined axial interference. This effectively prevents muddy water from flowing through the gap between the side surface 6c of the wheel mounting flange 6 and the weir portion 67d and the seal 66 from being directly splashed by muddy water even if the muddy water splashes over the outer circumference of the outer member 5 during running of the vehicle. Thus, it is possible to improve the durability and sealability of the seal 66 for a long term.

FIG. 15(b) shows a modification of the outside seal 79 of FIG. 15(a). An outside seal 81 of this modification is fit onto the inner-side base portion 6b of the wheel mounting flange 6. The outside seal 81 is press-formed of steel sheet with corrosion resistance. A cylindrical fitting portion 81a is fit onto a stepped portion 82 formed on the base portion 6b of the wheel mounting flange 6. A bent portion 81b extends radially outward from the fitting portion 81a. The side lip 80 of synthetic rubber such as NBR is integrally adhered to the bent portion 81b by vulcanizing adhesion. The side lip 80 slidably contacts the weir portion 67d of the metal core 67, via a predetermined axial interference. This effectively prevents the seal 66 from being directly splashed by muddy water, and muddy water from flowing through the gap between the side surface 6c of the wheel mounting flange 6 and the weir portion 67d.

FIG. 16 shows other modification of the outside seal 79 of FIG. 15(a). A metal core 84 of the seal 83 is arranged opposite to the inner-side side surface 6c of the wheel mounting flange 6. The seal 83 is formed as an integrated seal with the metal core 84 press-fit onto the outer-side end outer circumference of the outer member 5. A sealing member 13 is adhered to the metal core 84.

The metal core 84 is press-formed from a steel sheet with corrosion resistance such as austenitic-stainless steel sheet (JIS SUS 304 etc.) or preserved cold rolled steel sheet (JIS SPCC etc.) and has a generally annular configuration.

According to this modification, the metal core 84 includes the fitting portion 67a press-fit onto the outer-side end outer circumference of the outer member 5. The flange portion 67b extends radially inward from the fitting portion 67a. The flange portion is in close contact with the outer-side end face 5c of the outer member 5. The radially inner portion 67c is bent and then extends radially inward from the flange portion 67b. A weir portion 84a extends radially outward from the fitting portion 67a. A cylindrical overhang portion 84b extends axially toward outer-side from the weir portion 84a. A bent portion 84c extends further radially outward from the overhang portion 84b. All portions are integrally formed. Such a metal core 84 with a bent configuration increases its strength and rigidity. Thus, it prevents the metal core 84 from interfering with other parts during assembly of the bearing apparatus and from being plastically deformed by impingement of pebbles etc. during running of the vehicle. In addition, the weir portion 84a can effectively prevent muddy water from flowing through the gap between the side surface 6c of the wheel mounting flange 6 and the weir portion 84a even if the muddy water splashes over the outer circumference of the outer member 5 during running of the vehicle.

In addition, the bent portion 84c is arranged opposite to the inner-side side surface 6c of the wheel mounting flange 6, via a small axial gap, to form a labyrinth seal 85. Thus, it is possible to prevent the seal 83 from being directly splashed by muddy water. This improves the durability and sealability of the seal 83 for a long term.

FIG. 17 shows another modification of the seal 83 of FIG. 16. In the seal 86 shown in FIG. 17(a), the metal core 87 is arranged opposite to heads 88 of the hub bolts 6a of the wheel mounting flange 6. The seal 86 is formed as an integrated seal with the metal core 87 press-fit onto the outer-side end outer circumference of the outer member 5. The sealing member 13 is adhered to the metal core 87.

The metal core 87 is press-formed from a steel sheet with corrosion resistance such as austenitic-stainless steel sheet (JIS SUS 304 etc.) or preserved cold rolled steel sheet (JIS SPCC etc.) and has a generally annular configuration.

According to this modification, the metal core 87 includes the fitting portion 67a press-fit onto the outer-side end outer circumference of the outer member 5. The flange portion 67b extends radially inward from the fitting portion 67a. The flange portion 67b is in close contact with the outer-side end face 5c of the outer member 5. The radially inner portion 67c is bent and then extends radially inward from the flange portion 67b. A weir portion 87a extends radially outward from the fitting portion 67a. A cylindrical overhang portion 87b extends axially toward the outer-side from the weir portion 87a. A bent portion 87c extends further radially outward from the overhang portion 87b. All portions are integrally formed. Such a metal core 87 with a bent configuration increases its strength and rigidity. Thus, it prevents the metal core 87 from interfering with other parts during assembly of the bearing apparatus and from being plastically deformed by impingement of pebbles etc. during running of the vehicle. In addition, the weir portion 87a can effectively prevent muddy water from flowing through the gap between the side surface 6c of the wheel mounting flange 6 and the weir portion 87a even if the muddy water splashes over the outer circumference of the outer member 5 during running of a the vehicle.

Similarly to the previously described modification, a seal 89 shown in FIG. 17(b) has a metal core 90 arranged opposite to heads 88 of the hub bolts 6a of the wheel mounting flange 6. The seal 89 is formed as an integrated seal with the metal core 90 press-fit onto the outer-side end outer circumference of the outer member 5. The sealing member 13 is adhered to the metal core 90.

The metal core 90 is press-formed from a steel sheet with corrosion resistance such as austenitic-stainless steel sheet (JIS SUS 304 etc.) or preserved cold rolled steel sheet (JIS SPCC etc.) and has a generally annular configuration.

According to this modification, the metal core 90 includes the fitting portion 67a press-fit onto the outer-side end outer circumference of the outer member 5. The flange portion 67b extends radially inward from the fitting portion 67a. The flange portion 67b is in close contact with the outer-side end face 5c of the outer member 5. The radially inner portion 67c is bent and then extends radially inward from the flange portion 67b. A weir portion 90a is inclined radially outward from the fitting portion 67a. The weir portion 90a can prevent muddy water from flowing through the gap between the side surface 6c of the wheel mounting flange 6 and the weir portion 90a even if the muddy water splashes over the outer circumference of the outer member 5 during running of the vehicle.

The present disclosure can be applied to wheel bearing apparatus of the second, third and fourth generation type where seals are arranged in annular openings between an inner member, forming a rotor-side member, and an outer member, forming a stator-side member.

The present disclosure has been described with reference to the preferred embodiments. Obviously, modifications and alternations will occur to those of ordinary skill in the art upon reading and understanding the preceding detailed description. It is intended that the present disclosure be construed as including all such alternations and modifications insofar as they come within the scope of the appended claims or their equivalents.

What is claimed is:

1. A vehicle wheel bearing apparatus comprising:
an outer member formed with a body mounting flange on its outer circumference, the body mounting flange to be mounted on a knuckle, the outer member inner circumference includes double row outer raceway surfaces;
an inner member includes a wheel hub and at least one inner ring or an outer joint member of a constant velocity universal joint, the wheel hub is formed on its one end with a wheel mounting flange, a cylindrical portion axially extends from the wheel mounting flange, the inner ring or the outer joint member is fit to the cylindrical portion of the wheel hub, the inner member is formed with inner raceway surfaces on its outer circumference, the inner raceway surfaces oppose the double row outer raceway surfaces;
double row rolling elements are rollably contained between the inner raceway surfaces of the inner member and the outer raceway surfaces of the outer member;
seals are mounted within annular openings formed between the outer member and the inner member;
an outer-side seal of the seals comprises a metal core and a sealing member, the metal core includes a cylindrical fitting portion press-fit into the end of inner circumference of the outer member, a radially inner portion extends radially inward from the fitting portion, the sealing member is integrally adhered to the metal core, a side lip is inclined radially outward; and
either one of the metal core or the sealing member includes a weir portion extending radially outward from the fitting portion of the metal core, the weir portion opposes the inner-side surface of the wheel mounting flange, via a small axial gap to form a labyrinth seal, and the weir portion also opposes the outer-side end face of the outer member via a predetermined axial gap to form an annular discharging groove.

2. A vehicle wheel bearing apparatus comprising:
an outer member formed with a body mounting flange on its outer circumference, the body mounting flange to be mounted on a knuckle, the outer member inner circumference includes double row outer raceway surfaces;
an inner member includes a wheel hub and at least one inner ring or an outer joint member of a constant velocity universal joint, the wheel hub is formed on its one end with a wheel mounting flange, a cylindrical portion axially extends from the wheel mounting flange, the inner ring or the outer joint member is fit to the cylindrical portion of the wheel hub, the inner member is formed with inner raceway surfaces on its outer circumference, the inner raceway surfaces oppose the double row outer raceway surfaces;
double row rolling elements are freely rollably contained between the inner raceway surfaces of the inner member and the outer raceway surfaces of the outer member;
seals are mounted within annular openings formed between the outer member and the inner member;
an outer-side seal of the seals is formed as a integrated seal with a metal core and a sealing member; the metal core includes a cylindrical fitting portion press-fit into the end of outer circumference of the outer member, a flange portion extends radially inward from the fitting portion, the flange portion is in close contact with the outer-side end face of the outer member, a radially inner portion is bent and extends radially inward from the flange portion, the sealing member is integrally adhered, by vulcanizing adhesion, to the radially inner portion of the metal core, the sealing member also including an integrally formed side lip that is inclined radially outward and slidably contacts the inner-side base portion of the wheel mounting flange via an axial interference, and either the metal core or the sealing member is formed with an annular disc-shaped weir portion extending radially outward from the fitting portion of the metal core.

3. The vehicle wheel bearing apparatus of claim 1, wherein the weir portion is formed from a steel sheet integrally with the metal core by press working.

4. The vehicle wheel bearing apparatus of claim 1, wherein the weir portion is formed so that it has an outer diameter larger than that of the outer-side end outer circumference of the outer member.

5. The vehicle wheel bearing apparatus of claim 1, wherein the weir portion is inclined toward the wheel mounting flange.

6. The vehicle wheel bearing apparatus of claim 2, wherein the weir portion is inclined toward the inner-side of the wheel bearing apparatus.

7. The vehicle wheel bearing apparatus of claim 2, wherein the metal core has a cylindrical overhanging portion extending axially toward an outer-side from the weir portion and a bent portion extending radially outward from the overhanging portion and the bent portion opposes the inner-side surface of the wheel mounting flange via a small axial gap to form a labyrinth seal.

8. The vehicle wheel bearing apparatus of claim 2, wherein the sealing member, has a covering portion covering an exposed surface of the metal core.

9. The vehicle wheel bearing apparatus of claim 1, wherein the metal core has a flange portion extending radially outward between the fitting portion and the weir portion and is in close contact with the outer-side end face of the outer member.

10. The vehicle wheel bearing apparatus of claim 1, wherein the sealing member is secured to the metal core so that the sealing member is extended to part of the fitting portion.

11. The vehicle wheel bearing apparatus of claim 1, wherein the metal core is continuously covered by the sealing member in a region from the fitting portion to the weir portion.

12. The vehicle wheel bearing apparatus of claim 1, wherein the sealing member covers the fitting portion and the weir portion is integrally formed by the sealing member.

13. The vehicle wheel bearing apparatus of claim 1, wherein the inner-side base portion of the wheel mounting flange is formed as a curved surface with a circular arc cross-section, the sealing member further has an integrally formed dust lip that is inclined radially outward at a radially inner position from the side lip and an integrally formed grease lip inclined toward the inner-side of the bearing, and the side lip and the dust lip slidably contact the base portion via a predetermined axial interference and the grease lip is also slidably contact the base portion via a predetermined radial interference.

14. The vehicle wheel bearing apparatus of claim 1, wherein the inner-side base portion of the wheel mounting flange is formed as a curved surface with a circular arc cross-section and an annular metal member is fit on the base portion, the sealing member further has an integrally formed dust lip inclined radially outward at a radially inner position from the side lip and an integrally formed grease lip inclined toward the inner-side of the bearing, and the side lip and the dust lip slidably contact the annular metal member via a predetermined axial interference and the grease lip is also slidably contacts the annular metal member via a predetermined radial interference.

15. The vehicle wheel bearing apparatus of claim 14, wherein the annular metal member comprises a curved portion formed with circular arc cross-section corresponding to the curved surface of the base portion, an annular disc-shaped portion extends radially outward from the curved portion and is adapted to be in close contact with the inner-side surface of the wheel mounting flange, and a cylindrical ceiling portion axially extending toward a direction away from the wheel mounting flange, and the ceiling portion is arranged opposite the outer-side end outer circumference of the outer member via a small gap to form a labyrinth seal.

16. The vehicle wheel bearing apparatus of claim 15, wherein the annular metal member has a bent portion projecting radially outward from the ceiling portion.

17. The vehicle wheel bearing apparatus of claim 14, wherein the base portion is formed with a predetermined radius of curvature “r” and the curved portion of the annular metal member is formed with a predetermined radius of curvature “R”, and a relationship R≧r exist between the radii of curvature “R” and “r”.

18. The vehicle wheel bearing apparatus of claim 14, wherein the annular metal member is formed of corrosion resistant steel sheet, and wherein the steel sheet has a surface roughness of Ra 0.2-0.6.

19. The vehicle wheel bearing apparatus of claim 1, wherein the seal is formed as a pack seal with an annular sealing plate and a slinger mounted on the inner member, the sealing plate includes a metal core fit into the end portion of the outer member and a sealing member integrally adhered to the metal core, the slinger includes a cylindrical fitting portion press-fit onto the inner member via a predetermined interference and a standing plate portion extending radially outward from the fitting portion, the sealing member further has another integrally formed side lip inclined radially outward at a radially inner position from the side lip and an integrally formed grease lip inclined toward the inner-side of the bearing, and the side lips slidably contact the standing plate portion of the slinger via a predetermined axial interference and the grease lip slidably contacts the fitting portion of the slinger via a predetermined radial interference.

20. The vehicle wheel bearing apparatus of claim 2, wherein an outside seal is arranged in addition to the seal and the outside seal has a side lip slidably contacting the side surface of the weir portion of the metal core via a predetermined axial interference.

21. The vehicle wheel bearing apparatus of claim 20, wherein the outside seal includes a fitting portion fit onto the outer circumference of the wheel mounting flange, an annular disc-shaped portion extends radially inward from the fitting portion and is in close contact with an inner-side surface of the wheel mounting flange, a cylindrical overhang portion is bent toward an axially inner-side from the annular disc-shaped portion, and the side lip is integrally adhered to the overhang portion by vulcanizing adhesion, the outside seal is secured to the wheel mounting flange by hub bolts secured on the wheel mounting flange.

22. The vehicle wheel bearing apparatus of claim 20, wherein the outside seal includes a fitting portion fit onto a stepped portion formed on the base portion of the wheel mounting flange, a bent portion extends radially outward from the fitting portion, and the side lip is integrally adhered to the bent portion by vulcanizing adhesion.
